(19) United States
(12) Patent Application Publication
(10) Pub. No.: US 2008/0020932 A1
(43) Pub. Date: Jan. 24, 2008

(54) Method for Combating Weeds

(75) Inventors: Markus Dollinger, Lyon (FR); Frederic Top, Sathonay-Camp (FR); Ernst Rudolf Gesing, Erkrath (DE); Erwin Hacker, Hochheim (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer Cropscience AG, Monheim (DE)

(21) Appl. No.: 10/591,673

(22) PCT Filed: Feb. 19, 2005
(86) PCT No.: PCT/EP05/01735

§ 371 Date: Jun. 13, 2007

(30) Foreign Application Priority Data
Mar. 5, 2004 (DE) 102004010812.9

(51) Int. Cl. A01N 47/38

(52) U.S. Cl. 504/273

(57) ABSTRACT

The present invention relates to the new use of the compound 5-methoxy-4-methyl-2-[(4-methoxycarbonyl-2-methylthien-3-yl)sulfonylaminocarbonyl]-2,4-dihydro-3H-1,2,4-triazol-3-one of the formula (I) 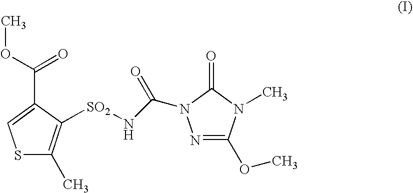
and/or of salts of the compound of the formula (I) for selectively controlling weeds of the genus Apera in crops of useful plants, and also to the corresponding agricultural method.

The invention relates to the use of the known compound 4-[[[(3-methoxy-4,5-dihydro-4-methyl-5-oxo-1H-1,2,4-triazol-1-yl)carbonyl]amino]sulfonyl]-5-methylthiophene-3-carboxylic acid methyl ester (alias 5-methoxy-4-methyl-2-[(4-methoxycarbonyl-2-methylthien-3-yl)sulfonylaminocarbonyl]-2,4-dihydro-3H-1,2,4-triazol-3-one; “compound of the formula (I)”) and also of its salts, especially its sodium salt, for selectively controlling problem weeds of the genus Apera in crops of useful plants, especially for controlling these weeds in cereal and corn crops.

Substituted thienylsulfonylaminocarbonyltriazolinones, and also their salts, processes for preparing these compounds, and their usefulness as herbicides, are subject matter of earlier patent applications (cf. WO 01/05788, WO 03/026427, WO 03/026426). The substituted thienylsulfonylaminocarbonyltriazolinones described in these patent applications alongside the compound of the formula (I) have a molecular structure very similar to that of the formula (I) for inventive use but still exhibit—unlike that compound—weaknesses or gaps in effect with respect to certain weed plants, such as Apera species, for example.

Surprisingly it has now been found that the compound of the formula (I) specifically, and especially when used together with a safener, combines very good tolerance by cereals, such as wheat in particular and by corn varieties, in comparison with the aforementioned structurally similar compounds, with a considerably stronger action against certain difficult-to-control weeds of the genus Apera in cereal crops or corn crops and is therefore especially suitable for efficiently and selectively controlling weeds of the genus Apera, particularly in wheat and corn. The gaps in action observed with the aforementioned comparison compounds closely related to the compound of the formula (i) do not occur in the weed spectrum of the compound of the formula (I) and its salts.

The invention provides for the use of the compound 5-methoxy-4-methyl-2-[(4-methoxycarbonyl-2-methylthien-3-yl)sulfonylaminocarbonyl]-2,4-dihydro-3H-1,2,4-triazol-3-one of the formula (I) 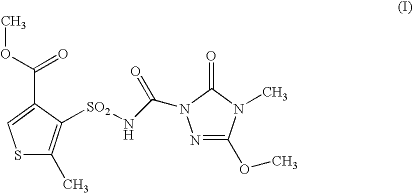
and/or of the salts of the compound of the formula (I) for selectively controlling weeds of the genus Apera in crops of useful plants, especially cereal crops, such as in wheat crops, or corn crops.

The invention further provides a method of selectively controlling weeds of the genus Apera in crops of useful plants, especially cereal crops, in particular such as in wheat crops, or corn crops, which comprises applying the compound of the formula (I) and/or salts of the compound of the formula (I) together with surface-active agents and/or customary extenders in crops of useful plants, cereal crops or corn crops.

The compound of the formula (I) is known (cf. WO 01/05788).

The compound of the formula (I) exhibits a broad herbicidal activity. It can likewise be used for controlling the following weeds, especially in corn and cereal crops:

Dicotyledonous weeds of the following genera: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum.

Monocotyledonous weeds of the following genera: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus, Aegilops, Phalaris.

The use of the compound (I) and of its salts is by no means restricted to these genera, however, but extends equally to other plants as well.

The compound of the formula (I) and also its salts display strong herbicidal activity and a broad spectrum of action when applied to the soil and to above-soil parts of plants. They are suitable for selectively controlling monocotyledonous and dicotyledonous weeds in monocotyledonous crops, particularly in cereals, especially in wheat, and also in corn crops, both preemergence and postemergence.

The tolerance by crop plants can be increased by adding a safener to the herbicidal compositions comprising the compound of the formula (I).

The following groups of compounds are particularly suitable safeners:
1) Compounds of the dichlorophenylpyrazoline-3-carboxylic acid type, preferably compounds such as 1-(2,4-dichlorophenyl)-5-(ethoxycarbonyl)-5-methyl-2-pyrazoline-3-carboxylic acid ethyl ester (S 1-1, mefenpyr-diethyl, known from e-Pesticide Manual of the British Crop Protection council, 2002-2003, 12^{th} edition, Editor C.D.S. Tomlin=“e-PM”), and related compounds, as described in WO 91/07874.
2) Derivatives of dichlorophenylpyrazolecarboxylic acid, preferably compounds such as 1-(2,4-dichlorophenyl)-5-methylpyrazole-3-carboxylic acid ethyl ester (S 1-2), 1-(2,4-dichlorophenyl)-5-isopropylpyrazole-3-carboxylic acid ethyl ester (S 1-3), 1-(2,4-dichlorophenyl)-5-(1,1-dimethylethyl)pyrazole-3-carboxylic acid ethyl ester (S 1-4), 1-(2,4-dichlorophenyl)-5-phenylpyrazole-3-carboxylic acid ethyl ester (S 1-5), and related compounds, as described in EP-A-333 131 and EP-A-269 806.
3) Compounds of the triazolcarboxylic acid type, preferably compounds such as fenchlorazole, i.e., 1-(2,4-dichlorophenyl)-5-trichloromethyl-(1 H)-1,2,4-triazole-3-carboxylic acid ethyl ester (S 1-6, fenchlorazole-ethyl, known from the e-PM), and related compounds (see EP-A-174 562 and EP-A-346 620).
4) Compounds of the 5-benzyl- or 5-phenyl-2-isoxazoline-3-carboxylic acid type or of the 5,5-diphenyl-2-isoxazoline-3-carboxylic acid type, preferably compounds such as 5-(2,4-dichlorobenzyl)-2-isoxazoline-3-carboxylic acid ethyl ester (S 1-7) or 5-phenyl-2-isoxazoline-3-carboxylic acid ethyl ester (S 1-8), and related compounds, as described in WO 91/08202, or 5,5-diphenyl-2-isoxazolinecarboxylic acid ethyl ester (S 1-9, isoxadifen-ethyl) or n-propyl ester (S 1-10) or 5-(4-fluorophenyl)-5-phenyl-2-isoxazoline-3-carboxylic acid ethyl ester (S 1-11), as are described in the patent application WO-A-95/07897).
5) Compounds of the 8-quinolinoxyacetic acid type (S2), preferably (5-chloro-8-quinolinoxy)acetic acid 1-methylhex-1-yl ester (S 2-1 cloquintocet-mexyl, known from e-PM), (5-chloro-8-quinolinoxy)acetic acid 1,3-dimethylbut-1-yl ester (S2-2), (5-chloro-8-quinolinoxy)acetic acid 4-allyloxybutyl ester (S2-3), (5-chloro-8-quinolinoxy)acetic acid 1-allyloxyprop-2-yl ester (S2-4), (5-chloro-8-quinolinoxy)acetic acid ethyl ester (S2-5), (5-chloro-8-quinolinoxy)acetic acid methyl ester (S2-6), (5-chloro-8-quinolinoxy)acetic acid allyl ester (S2-7), (5-chloro-8-quinolinoxy)acetic acid 2-(2-propylideneiminoxy)-1-ethyl ester (S2-8), (5-chloro-8-quinolinoxy)acetic acid 2-oxoprop-1-yl ester (S2-9), and related compounds, as described in EP-A-86 750, EP-A-94 349, and EP-A-191 736 or EP-A-0 492 366.
6) Compounds of the (5-chloro-8-quinolinoxy)malonic acid type, preferably compounds such as (5-chloro-8-quinolinoxy)malonic acid diethyl ester, (5-chloro-8-quinolinoxy)malonic diallyl ester, (5-chloro-8-quinolinoxy)malonic acid methyl ethyl ester, and related compounds, as described in EP-A-0 582 198.
7) Active ingredients of the pyrimidine type, such as “fenclorim” (known from e-PM of the British Crop Protection council, 2002-2003, 12^{th} edition, Editor C.D.S. Tomlin=“e-PM”) (=4,6-dichloro-2-phenylpyrimidine),
8) active ingredients of the dichloroacetamide type, which are frequently employed as preemergence safeners (soil-active safeners), such as
   “dichlormid” (e-PM) (═N,N-diallyl-2,2-dichloroacetamide),
   “R-29148” (=3-dichloroacetyl-2,2,5-trimethyl-1,3-oxazolidone from Stauffer),
   “benoxacor” (e-PM) (=4-dichloroacetyl-3,4-dihydro-3-methyl-2H-1,4-benzoxazine).
   “PPG-1292” N-allyl-N-[(1,3-dioxolan-2-yl)methyl]dichloroacetamide from PPG Industries),
   “DK-24” (═N-allyl-N-[(allylaminocarbonyl)methyl]dichloroacetamide from Sagro-Chem), “AD-67” or “MON 4660” (=3-dichloroacetyl-1-oxa-3-azaspiro[4.5]decane from Nitrokemia or Monsanto),
   “Dicyclonon” or “BAS145138” or “LAB145138” (=(=3-dichloroacetyl-2,5,5-trimethyl-1,3-diazabicyclo[4.3.0]nonane from BASF), and
   “furilazole” or “MON 13900” (e-PM) (═(RS)-3-dichloroacetyl-5-(2-furyl)-2,2-dimethyloxazolidone)
9) active ingredients of the dichloroacetone derivative type, such as
   “MG 191” (CAS Reg. No. 96420-72-3) (=2-dichloromethyl-2-methyl-1,3-dioxolane from Nitrokemia),
10) active ingredients of the oxyimino compound type, which are known as seed-dressing agents, such as
   “oxabetrinil” (e-PM) (=(Z)-1,3-dioxolan-2-ylmethoxy-imino(phenyl)acetonitrile), which is known as a seed-dressing safener to counter damage from metolachlor,
   “fluxofenim” (e-PM) (=1-(4-chlorophenyl)-2,2,2-trifluoro-1-ethanone O-(1,3-dioxolan-2-ylmethyl)oxime, which is known as a seed-dressing safener to counter damage from metolachlor, and
   “cyometrinil” or “CGA-43089” (e-PM) (=(Z)-cyanomethoxy-imino(phenyl)acetonitrile), which is known as a seed-dressing safener to counter damage from metolachlor,
11) active ingredients of the thiazolcarboxylic ester type, which are known as seed-dressing agents, such as
   “flurazole” (e-PM) (=2-chloro-4-trifluoromethyl-1,3-thiazole-5-carboxylic acid benzyl ester), which is known as a seed-dressing safener to counter damage from alachlor and metolachlor,
12) active ingredients of the naphthalenedicarboxylic acid derivative type, which are known as seed-dressing agents, such as
   “naphthalic anhydride” (e-PM) (=1,8-naphthalenedicarboxylic anhydride), which is known as a seed-dressing safener for corn to counter damage from thiocarbamate herbicides,
13) active ingredients of the chromanacetic acid derivative type, such as
   “CL 304415” (CAS Reg. No. 31541-57-8) (=2-84-carboxy-chroman-4-yl)acetic acid from American Cyanamid),
14) active ingredients which as well as a herbicidal action against weed plants also exhibit safener action in crop plants, such as
   “dimepiperate” or “MY-93” (e-PM) (=piperidine-1-thiocarboxylic acid S-1-methyl-1-phenylethyl ester),
   “daimuron” or “SK 23” (e-PM) (=1-(1-methyl-1-phenylethyl)-3-p-tolylurea),
   “cumyluron”=“JC-940” (=3-(2-chlorophenylmethyl)-1-(1-methyl-1-phenylethyl)urea, see JP-A-60087254),
   “methoxyphenone” or “NK 049” (=3,3′-dimethyl-4-methoxybenzo-phenone),
   “CSB” (=1-bromo-4-(chloromethylsulfonyl)benzene) (CAS Reg. No. 54091-064 from Kumiai), and

compounds of the acylsulfamoylbenzoamide type, of, for example, the following formula (II), which are known for example from WO 99/16744.

| | |
|---|---|
| | (II) |
| 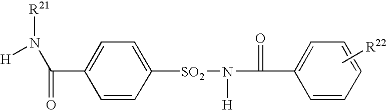 | |

| Compound No. | R²¹ | R²² |
|---|---|---|
| S 3-1 | cyclopropyl | 2-OCH₃ |
| S 3-2 | cyclopropyl | 2-OCH₃, 5-Cl |
| S 3-3 | ethyl | 2-OCH₃ |
| S 3-4 | isopropyl | 2-OCH₃, 5-Cl |
| S 3-5 | isopropyl | 2-OCH₃ |

Preferred safeners are benoxacor, mefenpyr, fenchlorazole, isoxadifen, cloquintocet, and their C₁-C₁₀ alkyl esters, especially benoxacor (S 4-1), mefenpyr-diethyl (S 1-1), fenchlorazole-ethyl (S 1-6), isoxadifen-ethyl (S 1-9), cloquintocet-mexyl (S 2-1), and (S 3-1).

The herbicidal compositions not a subject of specific prior description in WO 03/026427, and comprising an active ingredient combination composed of a compound of the formula (I) and one of the safeners stated in this specification, are likewise provided by the present specification. They are especially suitable for selectively controlling weeds in cereal and corn crops.

It is to be considered surprising that, from a multiplicity of known safeners or antidotes capable of antagonizing the damaging action of a herbicide on the crop plants, it is specifically certain of the abovementioned safeners that are suitable for almost completely eliminating the damaging action of the active ingredient of the formula (I) and its salts, also where appropriate in combination with one or more of the known herbicidal co-components listed below, on the crop plants, without at the same time adversely affecting the herbicidal activity with respect to the weeds.

As co-components for combined application with the compound of the formula (I), mention may be made of the following compounds, which are known from the e-Pesticide Manual of the British Crop Protection council, 2002-2003, 12^{th} edition, Editor C.D.S. Tomlin, from WO 03/026426 or the references cited:

acetochlor (B.1), acifluorfen, acifluorfen-sodium (B.2), aclonifen (B.3), alachlor (B.4), alloxydim (B.5), alloxydim-sodium, (B.6), ametryn (B.7), amicarbazone (B.8), amidosulfuron (B.9), amitrole (B.10), anilofos (B.11), asulam (B.12), and asulam-sodium (B.13), atrazine (B.14), azafenidin (B.15), azimsulfuron (B.16), beflubutamid (B.17), benazolin (B.18), and benazolin-ethyl (B.19), benfluralin (B.20), benfuresate (B.21), bensulfuron-methyl (B.22), bentazone (B.23), benthiocarb (B.24), benzfendizone (B.25), benzobicyclon (B.26), benzofenap (B.274), bifenox (B.275), bispyribac-sodium (B.27), bromacil (B.28), bromobutide (B.29), bromofenoxim (B.30), bromoxynil (B.31), bromoxynyl-heptanoate (B.32), bromoxynil-octanoate (B.33), bromoxynil-potassium (B.34), butachlor (B.35), butafenacil (B.36), butralin (B.37), butroxydim (B.38), butylate (B.39), cafenstrole (B.40), carbetamide (B.41), carfentrazone-ethyl (B.42), chlometoxyfen (B.43), chloridazon (B.44), chlorimuron-ethyl (B.45), chlornitrofen (B.46), chlorotoluron (B.47), chlorsulfuron (B.48), cinidon-ethyl (B.50), cinmethylin (B.51), cinosulfuron (B.52), clefoxydim (B.53), clethodym (B.54), clodinafop-propargyl (B.55), clomazone (B.56), clomeprop (B.57), clopyralid (B.58), cloransulam-methyl (B.59), cumyluron (B.60), cyanazine (B.61), cyclosulfamuron (B.62), cycloxydim (B.63), cyhalofop-butyl (B.64), 2,4-D (B.65) and its salts (B.66), amines (B.67), and esters (B.68), desmedipham (B.69), dicamba (B.70) and its salts (B.71), dicamba-diolamine (B.72), dichlobenil (B.73), dichlorprop-P (B.74), diclofop-methyl (B.75), diclosulam (B.76), difenzoquat (B.77), difenzoquat metilsulfate (B.78), diflufenican (B.79), diflufenzopyr (B.80), dimefuron (B.81), dimepiperate (B.82), dimethachlor (B.83), dimethametryn (B.84), dimethenamid (B.85), dimthenamid-P (B.86), dimexyflam (B.87), diquat-dibromide (B.88), dithiopyr (B.89), diuron (B.90), dymron (B.91), EPTC (B.92), esprocarb (B.93), ethalfluralin (B.94), ethametsulfuron-methyl (B.95), ethofumesate (B.96), ethoxyfen (B.97), ethoxysulfuron (B.98) and its sodium salt (B.99), ethobenzanid (B.100), fenoxaprop-P-ethyl (B.101), fentrazimide (B.102), flamprop-M-methyl (B.103) and -M-isopropyl (B.104), flazasulfuron (B.105), florasulam (B.106), fluazofop-P-ethyl (B.107), fluazifop-P-butyl (B.108), flucarbazone-sodium (B.109), fluazolate (B.110), flufenacet (B.111), flufenpyr (B.112), flumetsulam (B.113), flumiclorac-pentyl (B.114), flumioxazin (B.115), flumipropyn (B.116), fluormeturon (B.117), fluorochloridone (B.118), fluoroglycofen-ethyl (B.119), flupoxam (B.120), flupropacil (B.121), flupyrsulfuron-methyl (B.122) and its sodium salt (B.123), flurenol (B.124), fluroxypyr (B.125) and its esters (B.126) such as fluroxypyr-meptyl (B.127), flurtamone (B.128), fluthiacet-methyl (B.129), fomesafen (B.130), foramsulfuron (B.131), glufosinate (B.132), glufosinate-ammonium (B.133), L-glufosinate (L-PCT) (B.277) and its salts (B.278) (cf. GB 2011416), bilanafos (L-PTC-L-alaninylalanine) (B.279), glyphosate (B.134), glyphosate-ammonium (B.135), glyphosate-isopropylammonium (B.136), glyphosate-sodium (B.137), glyphosate-trimesium (B.138), halosulfuron-methyl (B.139), haloxyfop (B.140), -methyl (B.141), —P-methyl (B.142), -ethoxyethyl (B.143) or -butyl (B.144), hexazinone (B.145), imazamethabenz-methyl (B.146), imazamox (B.147), imazapic (B.148), imazapyr (B.149), imazaquin (B.150), imazethpyr (B.151), imazosulfuron (B.152), indanofan (B.153), iodosulfuron-methyl-sodium (B.154), ioxynil (B.155), ioxynil-octanoate (B.156), ioxynil-sodium (B.157), isoproturon (B.158), isouron (B.159), isoxaben (B.160), isoxachlortole (B.161) ([4-chloro-2-(methylsulfonyl)phenyl](5-cyclopropyl-4-isoxazolyl)methanone, known from EP 470856), isoxaflutole (B.162), ketospiradox (B.163), lactofen (B.164), lenacil (B.165), linuron (B.166), MCPA (B.167), mecoprop-P (B.168), mefenacet (B.169), mesosulfuron-methyl (B.170) and its sodium salt (B.171), mesotrione (B.172), metamitron (B.173), metazachlor (B.174), methabenzthiazuron (B.175), metobromuron (B.176), metolachlor (B.177), S-metolachlor (B.178), metosulam (B.179), metoxuron (B.180), metribuzin (B.181), metsulfuron (B.182), metsulfuron-methyl (B.183), molinate (B.184), naproanilide (B.185), napropamide (B.186), neburon (B.187), nicosulfuron (B.188), norflurazon (B.189), orbencarb (B.190), oryzalin (B.191), oxadiargyl (B.192), oxadiazon (B.193), oxasulfuron (B.194), oxaziclomefone (B.195), oxyfluorfen (B.196), paraquat (B.197), pendimethalin (B.198), pendralin (B.199), penoxsulam (B.200), pentoxazone (B.201), penthoxamid (B.202), phenmedipham (B.203), pichloram (B.205), picolinafen (B.205), pinoxaden (2,2-dimethyl-8-(2,6-diethyl-4-methylphenyl)-1,2,4,5-tetrahydro-7-oxo-7H-pyrazolo[1,2-d][1,4,5]-oxadiazepin-9-yl propanoate; cf. WO 99/47525) (B.280), piperophos (B.206), pretilachlor (B.207), primisulfuron-methyl (B.208), profluazol (B.209), profoxydim (B.210), prometryn (B.211), propachlor (B.212), propanil (B.49), propaquizafop (B.213), propisochlor (B.214), propoxycarbazone-sodium (B.215), propyzamide (B.216), prosulfocarb (B.217), prosulfuron (B.218), pyraclonil (B.219) (1-(3-chloro-4,5,6,7-tetrahydropyrazolo[1,5-a]pyridine-2-yl)-5-(methyl-2-propynylamino)-1H-pyrazole-4-carbonitrile, known from WO 94/08999), pyraflufen-ethyl (B.220), pyrazolate (B.221), pyrazolsulfuron-ethyl (B.222), pyrazoxyfen (B.223), pyribenzoxym (B.224), pyributicarb (B.225), pyridafol (B.226), pyridate (B.227), pyridatol (B.228), pyriftalid (B.229), pyriminobac-methyl (B.230), pyrithiobac-sodium (B.231), quinchlorac (B.232), quinmerac (B.233), quinoclamine (B.234), quizalofop (B.235), -ethyl (B.236), P-ethyl (B.237) and —P-tefuryl (B.238), rimsulfuron (B.239), sethoxydim (B.240), simazine (B.241), sulcotrione (B.242), sulfentrazone (B.243), sulfometuron-methyl (B.244), sulfosate (B.245), sulfosulfuron (B.246), tebuthiuron (B.247), tepraloxydim (B.248), terbuthylazine (B.249), terbutryn (B.250), thenylchlor (B.251), thiazopyr (B.252), thifensulfuron-methyl (B.253), thiocarbazil (B.254), tralkoxydim (B.255), triallate (B.256), triasulfuron (B.276), tribenuron-methyl (B.257), triclopyr (B.258), tridiphane (B.259), trifloxysulfuron (B.260), trifluralin (B.261), triflusulfuron-methyl (B.262), tritosulfuron (B.263) (N-[[[4-methoxy-6-(trifluoromethyl)-1,3,5-triazin-2-yl]amino]carbonyl]-2-(trifluoromethyl)benzenesulfonamide (B.264), known from DE 4038430), N-[[[(4,6-dimethoxy-2-pyrimidinyl)amino]carbonyl]-3-(N-methyl-N-methylsulfonylamino])-2-pyridinesulfonamide (B.265), (cf. WO-A-92/10660), N-[[(4,6-dimethoxy-2-pyrimidinyl )amino]carbonyl]-3-(N-methyl-N-methylsulfonylamino)-2-pyridinesulfonamide (B.266), (cf. WO-A-92/10660), 4-(4,5-dihydro-4-methyl-5-oxo-3-trifluoromethyl-1H-1,2,4-triazol-1-yl)-2-(ethylsulfonylamino)-5-fluorobenzenecarbothioamide (B.267, HWH-4991, cf. WO-A-95/30661), 2-chloro-N-[1-(2,6-dichloro-4-difluoromethyl-phenyl)-4-nitro-1H-pyrazol-5-yl]propanecarboxamide (B.268, SLA5599, cf. EP-A-303153), [2-chloro-3-(4,5-dihydro-3-isoxazolyl)-4-methylsulfonylphenyl]-(5-hydroxy-1-methyl-1H-pyrazol-4-yl)methanone (B.269) (cf. WO-A-96/26206; WO-A-98/31681), [3-(4,5-dihydro-3-isoxazolyl)-2-methyl-4-methylsulfonylphenyl]-(5-hydroxy-1-methyl-1H-pyrazol-4-yl )methanone (B.270) (cf. WO-A-96/26206, WO-A-98/31681), [3-[2-chloro-3[(2,6-dioxocyclohexyl)carbonyl]-6-ethylsulfonylphenyl]-5-isoxazolyl]acetonitrile (B.271) (cf. WO-A-01/28341), 2-[2-chloro-4-methylsulfonyl-3-[(2,2,2-trifluoroethoxy)methyl]benzoyl]-1,3-cyclohexanedione (B .272) (cf. WO-A-01/28341), 2-[[5,8-dimethyl-1,1-dioxido-4-(2-pyrimidinyloxy)-3,4-dihydro-2H-thiochromen-6-yl]carbonyl]-1,3-cyclohexanedione (B.273) (cf. WO-A-01/28341).

L-Glufosinate (B.277) and bilanfos (B.279) have the following formulae:

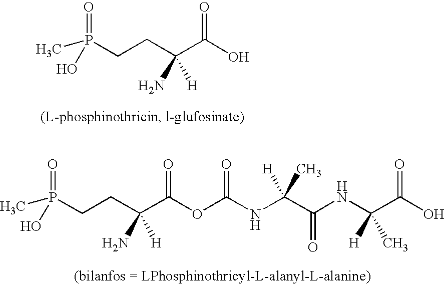

The combinations with the co-components are notable for the fact that the compound of the formula (I), when applied together with the known herbicidal compounds from different classes of compound, exhibit pronouncedly synergistic effects with respect to action against weeds and/or significantly enhance the tolerance by crop plants, and can be used with particular advantage as broad-spectrum combination products for selectively controlling weeds in crops of useful plants, such as in cotton, barley, corn, potatoes, rice, soya, sunflowers, wheat, and sugarcane, especially wheat and corn.

Surprisingly the herbicidal activity of the active ingredient combinations of the invention comprising the compound of the formula (I) and the co-components listed is considerably greater than the sum of the actions of the individual active ingredients.

Accordingly there is an unforeseeable synergistic effect and not merely an additive action. The active ingredient combinations are tolerated well in numerous crops, and provide effective control even of weeds which are otherwise difficult to control. The new active compound combinations therefore represent a valuable enrichment of herbicides.

The synergistic effect of the active ingredient combinations of the invention is particularly strongly pronounced at certain concentration ratios. Nevertheless it is possible to vary the weight ratios of the active ingredients in the active ingredient combinations within relatively wide ranges. Generally speaking, for 1 part by weight of active ingredient of the formula (I) there are preferably 0.05 to 100 parts by weight of the co-components. With particular preference the mixtures contain 0.1 to 10 parts by weight of the co-components per part by weight of active ingredient of the formula (I).

A synergistic effect exists for herbicides wherever the herbicidal action of the active ingredient combination is greater than that of the individual applied active ingredients.

The anticipated action for a given combination of two herbicides can be calculated as follows (cf. COLBY, S. R.: “Calculating synergistic and antagonistic responses of herbicide combinations”, Weeds 15, pages 20-22, 1967).

If

X=% damage by herbicide A (active ingredient of the formula I) at p kg/ha application rate

and

Y=% damage by herbicide B (active ingredient of the formula II) at q kg/ha application rate

and

E=the anticipated damage of herbicides A and B at p and q kg/ha application rate,

then
E=X+Y−(X*Y/100).

If the actual damage is greater than calculated, then the combination is superadditive in its action; that is, it exhibits a synergistic effect.

The active ingredient combinations comprising the compound of the formula (I) and other known herbicides and/or safeners in fact feature the property that their herbicidal action as found is greater than the calculated action; in other words the active ingredient combinations act synergistically.

As particularly suitable compositions, particular emphasis may be given to the following two-way combinations (compound of the formula (I)=A):

A+(B.1), A+(B.2), A+(B.3), A+B.4); A+(B.5), A+(B.6), A+(B.7), A+(B.8), A+(B.9), A+(B.10), A+(B.11), A+(B.12), A+(B.13), A+(B.14), A+(B.15), A+(B.16), A+(B.17), A+(B.18), A+(B.19), A+(B.20), A+(B.21), A+(B.22), A+(B.23), A+(B.24), A+(B.25), A+(B.26), A+(B.27), A+(B.28), A+(B.29), A+(B.30), A+(B.31), A+(B.32), A+(B.33), A+(B.34); A+(B.35), A+(B.36), A+(B.37), A+(B.38), A+(B.39), A+(B.40), A+(B.41), A+(B.42), A+(B.43), A+(B.44), A+(B.45), A+(B.46), A+(B.47), A+(B.48), A+(B.49), A+(B.50), A+(B.51), A+(B.52), A+(B.53), A+(B.54), A+(B.55), A+(B.56), A+(B.57), A+(B.58), A+(B.59), A+(B.60), A+(B.61), A+(B.62), A+(B.63), A+(B.64), A+(B.65), A+(B.66), A+(B.67), A+(B.68), A+(B.69), A+(B.70), A+(B.71), A+(B.72), A+(B.73), A+(B.74), A+(B.75), A+(B.76), A+(B.77), A+(B.78), A+(B.79), A+(B.80), A+(B.81), A+(B.82), A+(B.83), A+(B.84), A+(B.85), A+(B.86), A+(B.87), A+(B.88), A+(B.89), A+(B.90), A+(B.91), A+(B.92), A+(B.93), A+(B.94), A+(B.95), A+(B.96), A+(B.97), A+(B.98), A+(B.99), A+(B.100), A+(B.101), A+(B.102), A+(B.103), A+(B.104), A+(B.105), A+(B.106), A+(B.107), A+(B.108), A+(B.109), A+(B.110), A+(B.111), A+(B.112), A+(B.113), A+(B.114), A+(B.115), A+(B.116), A+(B.117), A+(B.118), A+(B.119), A+(B.120), A+(B.121), A+(B.122), A+(B.123), A+(B.124), A+(B.125), A+(B.126), A+(B.127), A+(B.128), A+(B.129), A+(B.130), A+(B.131), A+(B.132), A+(B.133), A+(B.134), A+(B.135), A+(B.136), A+(B.137), A+(B.138), A+(B.139), A+(B.140), A+(B.141), A+(B.142), A+(B.143), A+(B.144), A+(B.145), A+(B.146), A+(B.147), A+(B.148), A+(B.149), A+(B.150), A+(B.151), A+(B.152), A+(B.153), A+(B.154), A+(B.155), A+(B.156), A+(B.157), A+(B.158), A+(B.159), A+(B.160), A+(B.161), A+(B.162), A+(B.163), A+(B.164), A+(B.165), A+(B.166), A+(B.167), A+(B.168), A+(B.169), A+(B.170), A+(B.171), A+(B.172), A+(B.173), A+(B.174), A+(B.175), A+(B.176), A+(B.177), A+(B.178), A+(B.179), A+(B.180), A+(B.181), A+(B.182), A+(B.183), A+(B.184), A+(B.185), A+(B.186), A+(B.187), A+(B.188), A+(B.189), A+(B.190), A+(B.191), A+(B.192), A+(B.193), A+(B.194), A+(B.195), A+(B.196), A+(B.197), A+(B.198), A+(B.199), A+(B.200), A+(B.201), A+(B.202), A+(B.203), A+(B.204), A+(B.205), A+(B.206), A+(B.207), A+(B.208), A+(B.209), A+(B.210), A+(B.211), A+(B.212), A+(B.213), A+(B.214), A+(B.215), A+(B.216), A+(B.217), A+(B.218), A+(B.219), A+(B.220), A+(B.221), A+(B.222), A+(B.223), A+(B.224), A+(B.225), A+(B.226), A+(B.227), A+(B.228), A+(B.229), A+(B.230), A+(B.231), A+(B.232), A+(B.233), A+(B.234), A+(B.235), A+(B.236), A+(B.237), A+(B.238), A+(B.239), A+(B.240), A+(B.241), A+(B.242), A+(B.243), A+(B.244), A+(B.245), A+(B.246), A+(B.247), A+(B.248), A+(B.249), A+(B.250), A+(B.251), A+(B.252), A+(B.253), A+(B.254), A+(B.255), A+(B.256), A+(B.257), A+(B.258), A+(B.259), A+(B.260), A+(B.261), A+(B.262), A+(B.263), A+(B.264), A+(B.265), A+(B.266), A+(B.267), A+(B.268), A+(B.269), A+(B.270), A+(B.271), A+(B.272), A+(B.273), A+(B.274), A+(B.275), A+(B.276), A+(B.277), A+(B.278), A+(B.279), A+(B.280).

As particularly suitable compositions, particular emphasis may be given to the following combinations with safener (S 4-1) (compound of the formula (I)=A):

A+(S 4-1), A+(B.1)+(S 4-1), A+(B.2)+(S 4-1), A+(B.3)+(S 4-1), A+(B.4)+(S 4-1), A+(B.5)+(S 4-1), A+(B.6)+(S 4-1), A+(B.7)+(S 4-1), A+(B.8)+(S 4-1), A+(B.9)+(S 4-1), A+(B.10)+(S 4-1), A+(B.11)+(S 4-1), A+(B.12)+(S 4-1), A+(B.13)+(S 4-1), A+(B.14)+(S 4-1), A+(B.15)+(S 4-1), A+(B.16)+(S 4-1), A+(B.17)+(S 4-1), A+(B.18)+(S 4-1), A+(B.19)+(S 4-1), A+(B.20)+(S 4-1), A+(B.21)+(S 4-1), A+(B.22)+(S 4-1), A+(B.23)+(S 4-1), A+(B.24)+(S 4-1), A+(B.25)+(S 4-1), A+(B.26)+(S 4-1), A+(B.27)+(S 4-1), A+(B.28)+(S 4-1), A+(B.29)+(S 4-1), A+(B.30)+(S 4-1), A+(B.31)+(S 4-1), A+(B.32)+(S 4-1), A+(B.33)+(S 4-1), A+(B.34)+(S 4-1), A+(B.35)+(S 4-1), A+(B.36)+(S 4-1), A+(B.37)+(S 4-1), A+(B.38)+(S 4-1), A+(B.39)+(S 4-1), A+(B.40)+(S 4-1), A+(B.41)+(S 4-1), A+(B.42)+(S 4-1), A+(B.43)+(S 4-1), A+(B.44)+(S 4-1), A+(B.45)+(S 4-1), A+(B.46)+(S 4-1), A+(B.47)+(S 4-1), A+(B.48)+(S 4-1), A+(B.49)+(S 4-1), A+(B.50)+(S 4-1), A+(B.51)+(S 4-1), A+(B.52)+(S 4-1), A+(B.53)+(S 4-1), A+(B.54)+(S 4-1), A+(B.55)+(S 4-1), A+(B.56)+(S 4-1), A+(B.57)+(S 4-1), A+(B.58)+(S 4-1), A+(B.59)+(S 4-1), A+(B.60)+(S 4-1), A+(B.61)+(S 4-1), A+(B.62)+(S 4-1), A+(B.63)+(S 4-1), A+(B.64)+(S 4-1), A+(B.65)+(S 4-1), A+(B.66)+(S 4-1), A+(B.67)+(S 4-1), A+(B.68)+(S 4-1), A+(B.69)+(S 4-1), A+(B.70)+(S 4-1), A+(B.71)+(S 4-1), A+(B.72)+(S 4-1), A+(B.73)+(S 4-1), A+(B.74)+(S 4-1), A+(B.75)+(S 4-1), A+(B.76)+(S 4-1), A+(B.77)+(S 4-1), A+(B.78)+(S 4-1), A+(B.79)+(S 4-1), A+(B.80)+(S 4-1), A+(B.81)+(S 4-1), A+(B.82)+(S 4-1), A+(B.83)+(S 4-1), A+(B.84)+(S 4-1), A+(B.85)+(S 4-1), A+(B.86)+(S 4-1), A+(B.87)+(S 4-1), A+(B.88)+(S 4-1), A+(B.89)+(S 4-1), A+(B.90)+(S 4-1), A+(B.91)+(S 4-1), A+(B.92)+(S 4-1), A+(B.93)+(S 4-1), A+(B.94)+(S 4-1), A+(B.95)+(S 4-1), A+(B.96)+(S 4-1), A+(B.97)+(S 4-1), A+(B.98)+(S 4-1), A+(B.99)+(S 4-1), A+(B.100)+(S 4-1), A+(B.101)+(S 4-1), A+(B.102)+(S 4-1), A+(B.103)+(S 4-1), A+(B.104)+(S 4-1), A+(B.105)+(S 4-1), A+(B.106)+(S 4-1), A+(B.107)+(S 4-1), A+(B.108)+(S 4-1), A+(B.109)+(S 4-1), A+(B.110)+(S 4-1), A+(B.111)+(S 4-1), A+(B.112)+(S 4-1), A+(B.113)+(S 4-1), A+(B.114)+(S 4-1), A+(B.115)+(S 4-1), A+(B.116)+(S 4-1), A+(B.117)+(S 4-1), A+(B.118)+(S 4-1), A+(B.119)+(S 4-1), A+(B.120)+(S 4-1), A+(B.121)+(S 4-1), A+(B.122)+(S 4-1), A+(B.123)+(S 4-1), A+(B.124)+(S 4-1), A+(B.125)+(S 4-1), A+(B.126)+(S 4-1), A+(B.127)+(S 4-1), A+(B.128)+(S 4-1), A+(B.129)+(S 4-1), A+(B.130)+(S 4-1), A+(B.131)+(S 4-1), A+(B.132)+(S 4-1), A+(B.133)+(S 4-1), A+(B.134)+(S 4-1), A+(B.135)+(S 4-1), A+(B.136)+(S 4-1), A+(B.137)+(S 4-1), A+(B.138)+(S 4-1), A+(B.139)+(S 4-1), A+(B.140)+(S 4-1), A+(B.141)+(S 4-1), A+(B.142)+(S 4-1), A+(B.143)+(S 4-1), A+(B.144)+(S 4-1), A+(B.145)+(S 4-1), A+(B.146)+(S 4-1), A+(B.147)+(S 4-1), A+(B.148)+(S 4-1), A+(B.149)+(S 4-1), A+(B.150)+(S 4-1), A+(B.151)+(S 4-1), A+(B.152)+(S 4-1), A+(B.153)+(S 4-1), A+(B.154)+(S 4-1), A+(B.155)+(S 4-1), A+(B.156)+(S 4-1), A+(B.157)+(S 4-1), A+(B.158)+(S 4-1), A+(B.159)+(S 4-1), A+(B.160)+(S 4-1), A+(B.161)+(S 4-1), A+(B.162)+(S 4-1), A+(B.163)+(S 4-1), A+(B.164)+(S 4-1), A+(B.165)+(S 4-1), A+(B.166)+(S 4-1), A+(B.167)+(S 4-1), A+(B.168)+(S 4-1), A+(B.169)+(S 4-1), A+(B.170)+(S 4-1), A+(B.171)+(S 4-1), A+(B.172)+(S 4-1), A+(B.173)+(S 4-1), A+(B.174)+(S 4-1), A+(B.175)+(S 4-1), A+(B.176)+(S 4-1), A+(B.177)+(S 4-1), A+(B.178)+(S 4-1), A+(B.179)+(S 4-1), A+(B.180)+(S 4-1), A+(B.181)+(S 4-1), A+(B.182)+(S 4-1), A+(B.183)+(S 4-1), A+(B.184)+(S 4-1), A+(B.185)+(S 4-1), A+(B.186)+(S 4-1), A+(B.187)+(S 4-1), A+(B.188)+(S 4-1), A+(B.189)+(S 4-1), A+(B.190)+(S 4-1), A+(B.191)+(S 4-1), A+(B.192)+(S 4-1), A+(B.193)+(S 4-1), A+(B.194)+(S 4-1), A+(B.195)+(S 4-1), A+(B.196)+(S 4-1), A+(B.197)+(S 4-1), A+(B.198)+(S 4-1), A+(B.199)+(S 4-1), A+(B.200)+(S 4-1), A+(B.201)+(S 4-1), A+(B.202)+(S 4-1), A+(B.203)+(S 4-1), A+(B.204)+(S 4-1), A+(B.205)+(S 4-1), A+(B.206)+(S 4-1), A+(B.207)+(S 4-1), A+(B.208)+(S 4-1), A+(B.209)+(S 4-1), A+(B.210)+(S 4-1), A+(B.211)+(S 4-1), A+(B.212)+(S 4-1), A+(B.213)+(S 4-1), A+(B.214)+(S 4-1), A+(B.215)+(S 4-1), A+(B.216)+(S 4-1), A+(B.217)+(S 4-1), A+(B.218)+(S 4-1), A+(B.219)+(S 4-1), A+(B.220)+(S 4-1), A+(B.221)+(S 4-1), A+(B.222)+(S 4-1), A+(B.223)+(S 4-1), A+(B.224)+(S 4-1), A+(B.225)+(S 4-1), A+(B.226)+(S 4-1), A+(B.227)+(S 4-1), A+(B.228)+(S 4-1), A+(B.229)+(S 4-1), A+(B.230)+(S 4-1), A+(B.231)+(S 4-1), A+(B.232)+(S 4-1), A+(B.233)+(S 4-1), A+(B.234)+(S 4-1), A+(B.235)+(S 4-1), A+(B.236)+(S 4-1), A+(B.237)+(S 4-1), A+(B.238)+(S 4-1), A+(B.239)+(S 4-1), A+(B.240)+(S 4-1), A+(B.241)+(S 4-1), A+(B.242)+(S 4-1), A+(B.243)+(S 4-1), A+(B.244)+(S 4-1), A+(B.245)+(S 4-1), A+(B.246)+(S 4-1), A+(B.247)+(S 4-1), A+(B.248)+(S 4-1), A+(B.249)+(S 4-1), A+(B.250)+(S 4-1), A+(B.251)+(S 4-1), A+(B.252)+(S 4-1), A+(B.253)+(S 4-1), A+(B.254)+(S 4-1), A+(B.255)+(S 4-1), A+(B.256)+(S 4-1), A+(B.257)+(S 4-1), A+(B.258)+(S 4-1), A+(B.259)+(S 4-1), A+(B.260)+(S 4-1), A+(B.261)+(S 4-1), A+(B.262)+(S 4-1), A+(B.263)+(S 4-1), A+(B.264)+(S 4-1), A+(B.265)+(S 4-1), A+(B.266)+(S 4-1), A+(B.267)+(S 4-1), A+(B.268)+(S 4-1), A+(B.269)+(S 4-1), A+(B.270)+(S 4-1), A+(B.271)+(S 4-1), A+(B.272)+(S 4-1), A+(B.273)+(S 4-1), A+(B.274)+(S 4-1), A+(B.275)+(S 4-1), A+(B.276)+(S 4-1), A+(B.277)+(S 4-1), A+(B.278)+(S 4-1), A+(B.279)+(S 4-1), A+(B.280)+(S 4-1).

As particularly suitable compositions, particular emphasis may be given to the following two-way combinations with safener (S 1-1) (compound of the formula (I)=A):

A+(S 1-1), A+(B.1)+(S 1-1), A+(B.2)+(S 1-1), A+(B.3)+(S 1-1), A+(B.4)+(S 1-1), A+(B.5)+(S 1-1), A+(B.6)+(S 1-1), A+(B.7)+(S 1-1), A+(B.8)+(S 1-1), A+(B.9)+(S 1-1), A+(B.10)+(S 1-1), A+(B.11)+(S 1-1), A+(B.12)+(S 1-1), A+(B.13)+(S 1-1), A+(B.14)+(S 1-1), A+(B.15)+(S 1-1), A+(B.16)+(S 1-1), A+(B.17)+(S 1-1), A+(B.18)+(S 1-1), A+(B.19)+(S 1-1), A+(B.20)+(S 1-1), A+(B.21)+(S 1-1), A+(B.22)+(S 1-1), A+(B.23)+(S 1-1), A+(B.24)+(S 1-1), A+(B.25)+(S 1-1), A+(B.26)+(S 1-1), A+(B.27)+(S 1-1), A+(B.28)+(S 1-1), A+(B.29)+(S 1-1), A+(B.30)+(S 1-1), A+(B.31)+(S 1-1), A+(B.32)+(S 1-1), A+(B.33)+(S 1-1), A+(B.34)+(S 1-1), A+(B.35)+(S 1-1), A+(B.36)+(S 1-1), A+(B.37)+(S 1-1), A+(B.38)+(S 1-1), A+(B.39)+(S 1-1), A+(B.40)+(S 1-1), A+(B.41)+(S 1-1), A+(B.42)+(S 1-1), A+(B.43)+(S 1-1), A+(B.44)+(S 1-1), A+(B.45)+(S 1-1), A+(B.46)+(S 1-1), A+(B.47)+(S 1-1), A+(B.48)+(S 1-1), A+(B.49)+(S 1-1), A+(B.50)+(S 1-1), A+(B.51)+(S 1-1), A+(B.52)+(S 1-1), A+(B.53)+(S 1-1), A+(B.54)+(S 1-1), A+(B.55)+(S 1-1), A+(B.56)+(S 1-1), A+(B.57)+(S 1-1), A+(B.58)+(S 1-1), A+(B.59)+(S 1-1), A+(B.60)+(S 1-1), A+(B.61)+(S 1-1), A+(B.62)+(S 1-1), A+(B.63)+(S 1-1), A+(B.64)+(S 1-1), A+(B.65)+(S 1-1), A+(B.66)+(S 1-1), A+(B.67)+(S 1-1), A+(B.68)+(S 1-1), A+(B.69)+(S 1-1), A+(B.70)+(S 1-1), A+(B.71)+(S 1-1), A+(B.72)+(S 1-1), A+(B.73)+(S 1-1), A+(B.74)+(S 1-1), A+(B.75)+(S 1-1), A+(B.76)+(S 1-1), A+(B.77)+(S 1-1), A+(B.78)+(S 1-1), A+(B.79)+(S 1-1), A+(B.80)+(S 1-1), A+(B.81)+(S 1-1), A+(B.82)+(S 1-1), A+(B.83)+(S 1-1), A+(B.84)+(S 1-1), A+(B.85)+(S 1-1), A+(B.86)+(S 1-1), A+(B.87)+(S 1-1), A+(B.88)+(S 1-1), A+(B.89)+(S 1-1), A+(B.90)+(S 1-1), A+(B.91)+(S 1-1), A+(B.92)+(S 1-1), A+(B.93)+(S 1-1), A+(B.94)+(S 1-1), A+(B.95)+(S 1-1), A+(B.96)+(S 1-1), A+(B.97)+(S 1-1), A+(B.98)+(S 1-1), A+(B.99)+(S 1-1), A+(B.100)+(S 1-1), A+(B.101)+(S 1-1), A+(B.102)+(S 1-1), A+(B.103)+(S 1-1), A+(B.104)+(S 1-1), A+(B.105)+(S 1-1), A+(B.106)+(S 1-1), A+(B.107)+(S 1-1), A+(B.108)+(S 1-1), A+(B.109)+(S 1-1), A+(B.110)+(S 1-1), A+(B.111)+(S 1-1), A+(B.112)+(S 1-1), A+(B.113)+(S 1-1), A+(B.114)+(S 1-1), A+(B.115)+(S 1-1), A+(B.116)+(S 1-1), A+(B.117)+(S 1-1), A+(B.118)+(S 1-1), A+(B.119)+(S 1-1), A+(B.120)+(S 1-1), A+(B.121)+(S 1-1), A+(B.122)+(S 1-1), A+(B.123)+(S 1-1), A+(B.124)+(S 1-1), A+(B.125)+(S 1-1), A+(B.126)+(S 1-1), A+(B.127)+(S 1-1), A+(B.128)+(S 1-1), A+(B.129)+(S 1-1), A+(B.130)+(S 1-1), A+(B.131)+(S 1-1), A+(B.132)+(S 1-1), A+(B.133)+(S 1-1), A+(B.134)+(S 1-1), A+(B.135)+(S 1-1), A+(B.136)+(S 1-1), A+(B.137)+(S 1-1), A+(B.138)+(S 1-1), A+(B.139)+(S 1-1), A+(B.140)+(S 1-1), A+(B.141)+(S 1-1), A+(B.142)+(S 1-1), A+(B.143)+(S 1-1), A+(B.144)+(S 1-1), A+(B.145)+(S 1-1), A+(B.146)+(S 1-1), A+(B.147)+(S 1-1), A+(B.148)+(S 1-1), A+(B.149)+(S 1-1), A+(B.150)+(S 1-1), A+(B.151)+(S 1-1), A+(B.152)+(S 1-1), A+(B.153)+(S 1-1), A+(B.154)+(S 1-1), A+(B.155)+(S 1-1), A+(B.156)+(S 1-1), A+(B.157)+(S 1-1), A+(B.158)+(S 1-1), A+(B.159)+(S 1-1), A+(B.160)+(S 1-1), A+(B.161)+(S 1-1), A+(B.162)+(S 1-1), A+(B.163)+(S 1-1), A+(B.164)+(S 1-1), A+(B.165)+(S 1-1), A+(B.166)+(S 1-1), A+(B.167)+(S 1-1), A+(B.168)+(S 1-1), A+(B.169)+(S 1-1), A+(B.170)+(S 1-1), A+(B.171)+(S 1-1), A+(B.172)+(S 1-1), A+(B.173)+(S 1-1), A+(B.174)+(S 1-1), A+(B.175)+(S 1-1), A+(B.176)+(S 1-1), A+(B.177)+(S 1-1), A+(B.178)+(S 1-1), A+(B.179)+(S 1-1), A+(B.180)+(S 1-1), A+(B.181)+(S 1-1), A+(B.182)+(S 1-1), A+(B.183)+(S 1-1), A+(B.184)+(S 1-1), A+(B.185)+(S 1-1), A+(B.186)+(S 1-1), A+(B.187)+(S 1-1), A+(B.188)+(S 1-1), A+(B.189)+(S 1-1), A+(B.190)+(S 1-1), A+(B.191)+(S 1-1), A+(B.192)+(S 1-1), A+(B.193)+(S 1-1), A+(B.194)+(S 1-1), A+(B.195)+(S 1-1), A+(B.196)+(S 1-1), A+(B.197)+(S 1-1), A+(B.198)+(S 1-1), A+(B.199)+(S 1-1), A+(B.200)+(S 1-1), A+(B.201)+(S 1-1), A+(B.202)+(S 1-1), A+(B.203)+(S 1-1), A+(B.204)+(S 1-1), A+(B.205)+(S 1-1), A+(B.206)+(S 1-1), A+(B.207)+(S 1-1), A+(B.208)+(S 1-1), A+(B.209)+(S 1-1), A+(B.210)+(S 1-1), A+(B.211)+(S 1-1), A+(B.212)+(S 1-1), A+(B.213)+(S 1-1), A+(B.214)+(S 1-1), A+(B.215)+(S 1-1), A+(B.216)+(S 1-1), A+(B.217)+(S 1-1), A+(B.218)+(S 1-1), A+(B.219)+(S 1-1), A+(B.220)+(S 1-1), A+(B.221)+(S 1-1), A+(B.222)+(S 1-1), A+(B.223)+(S 1-1), A+(B.224)+(S 1-1), A+(B.225)+(S 1-1), A+(B.226)+(S 1-1), A+(B.227)+(S 1-1), A+(B.228)+(S 1-1), A+(B.229)+(S 1-1), A+(B.230)+(S 1-1), A+(B.231)+(S 1-1), A+(B.232)+(S 1-1), A+(B.233)+(S 1-1), A+(B.234)+(S 1-1), A+(B.235)+(S 1-1), A+(B.236)+(S 1-1), A+(B.237)+(S 1-1), A+(B.238)+(S 1-1), A+(B.239)+(S 1-1), A+(B.240)+(S 1-1), A+(B.241)+(S 1-1), A+(B.242)+(S 1-1), A+(B.243)+(S 1-1), A+(B.244)+(S 1-1), A+(B.245)+(S 1-1), A+(B.246)+(S 1-1), A+(B.247)+(S 1-1), A+(B.248)+(S 1-1), A+(B.249)+(S 1-1), A+(B.250)+(S 1-1), A+(B.251)+(S 1-1), A+(B.252)+(S 1-1), A+(B.253)+(S 1-1), A+(B.254)+(S 1-1), A+(B.255)+(S 1-1), A+(B.256)+(S 1-1), A+(B.257)+(S 1-1), A+(B.258)+(S 1-1), A+(B.259)+(S 1-1), A+(B.260)+(S 1-1), A+(B.261)+(S 1-1), A+(B.262)+(S 1-1), A+(B.263)+(S 1-1), A+(B.264)+(S 1-1), A+(B.265)+(S 1-1), A+(B.266)+(S 1-1), A+(B.267)+(S 1-1), A+(B.268)+(S 1-1), A+(B.269)+(S 1-1), A+(B.270)+(S 1-1), A+(B.271)+(S 1-1), A+(B.272)+(S 1-1), A+(B.273)+(S 1-1), A+(B.274)+(S 1-1), A+(B.275)+(S 1-1), A+(B.276)+(S 1-1), A+(B.277)+(S 1-1), A+(B.278)+(S 1-1), A+(B.279)+(S 1-1), A+(B.280)+(S 1-1).

As particularly suitable compositions, particular emphasis may be given to the following two-way combinations with safener (S 1-6) (compound of the formula (I)=A):

A+(S 1-6), A+(B.1)+(S 1-6), A+(B.2)+(S 1-6), A+(B.3)+(S 1-6), A+(B.4)+(S 1-6), A+(B.5)+(S 1-6), A+(B.6)+(S 1-6), A+(B.7)+(S 1-6), A+(B.8)+(S 1-6), A+(B.9)+(S 1-6), A+(B.10)+(S 1-6), A+(B.11)+(S 1-6), A+(B.12)+(S 1-6), A+(B.13)+(S 1-6), A+(B.14)+(S 1-6), A+(B.15)+(S 1-6), A+(B.16)+(S 1-6), A+(B.17)+(S 1-6), A+(B.18)+(S 1-6), A+(B.19)+(S 1-6), A+(B.20)+(S 1-6), A+(B.21)+(S 1-6), A+(B.22)+(S 1-6), A+(B.23)+(S 1-6), A+(B.24)+(S 1-6), A+(B.25)+(S 1-6), A+(B.26)+(S 1-6), A+(B.27)+(S 1-6), A+(B.28)+(S 1-6), A+(B.29)+(S 1-6), A+(B.30)+(S 1-6), A+(B.31)+(S 1-6), A+(B.32)+(S 1-6), A+(B.33)+(S 1-6), A+(B.34)+(S 1-6), A+(B.35)+(S 1-6), A+(B.36)+(S 1-6), A+(B.37)+(S 1-6), A+(B.38)+(S 1-6), A+(B.39)+(S 1-6), A+(B.40)+(S 1-6), A+(B.41)+(S 1-6), A+(B.42)+(S 1-6), A+(B.43)+(S 1-6), A+(B.44)+(S 1-6), A+(B.45)+(S 1-6), A+(B.46)+(S 1-6), A+(B.47)+(S 1-6), A+(B.48)+(S 1-6), A+(B.49)+(S 1-6), A+(B.50)+(S 1-6), A+(B.51)+(S 1-6), A+(B.52)+(S 1-6), A+(B.53)+(S 1-6), A+(B.54)+(S 1-6), A+(B.55)+(S 1-6), A+(B.56)+(S 1-6), A+(B.57)+(S 1-6), A+(B.58)+(S 1-6), A+(B.59)+(S 1-6), A+(B.60)+(S 1-6), A+(B.61)+(S 1-6), A+(B.62)+(S 1-6), A+(B.63)+(S 1-6), A+(B.64)+(S 1-6), A+(B.65)+(S 1-6), A+(B.66)+(S 1-6), A+(B.67)+(S 1-6), A+(B.68)+(S 1-6), A+(B.69)+(S 1-6), A+(B.70)+(S 1-6), A+(B.71)+(S 1-6), A+(B.72)+(S 1-6), A+(B.73)+(S 1-6), A+(B.74)+(S 1-6), A+(B.75)+(S 1-6), A+(B.76)+(S 1-6), A+(B.77)+(S 1-6), A+(B.78)+(S 1-6), A+(B.79)+(S 1-6), A+(B.80)+(S 1-6), A+(B.81)+(S 1-6), A+(B.82)+(S 1-6), A+(B.83)+(S 1-6), A+(B.84)+(S 1-6), A+(B.85)+(S 1-6), A+(B.86)+(S 1-6), A+(B.87)+(S 1-6), A+(B.88)+(S 1-6), A+(B.89)+(S 1-6), A+(B.90)+(S 1-6), A+(B.91)+(S 1-6), A+(B.92)+(S 1-6), A+(B.93)+(S 1-6), A+(B.94)+(S 1-6), A+(B.95)+(S 1-6), A+(B.96)+(S 1-6), A+(B.97)+(S 1-6), A+(B.98)+(S 1-6), A+(B.99)+(S 1-6), A+(B.100)+(S 1-6), A+(B.101)+(S 1-6), A+(B.102)+(S 1-6), A+(B.103)+(S 1-6), A+(B.104)+(S 1-6), A+(B.105)+(S 1-6), A+(B.106)+(S 1-6), A+(B.107)+(S 1-6), A+(B.108)+(S 1-6), A+(B.109)+(S 1-6), A+(B.110)+(S 1-6), A+(B.111)+(S 1-6), A+(B.112)+(S 1-6), A+(B.113)+(S 1-6), A+(B.114)+(S 1-6), A+(B.115)+(S 1-6), A+(B.116)+(S 1-6), A+(B.117)+(S 1-6), A+(B.118)+(S 1-6), A+(B.119)+(S 1-6), A+(B.120)+(S 1-6), A+(B.121)+(S 1-6), A+(B.122)+(S 1-6), A+(B.123)+(S 1-6), A+(B.124)+(S 1-6), A+(B.125)+(S 1-6), A+(B.126)+(S 1-6), A+(B.127)+(S 1-6), A+(B.128)+(S 1-6), A+(B.129)+(S 1-6), A+(B.130)+(S 1-6), A+(B.131)+(S 1-6), A+(B.132)+(S 1-6), A+(B.133)+(S 1-6), A+(B.134)+(S 1-6), A+(B.135)+(S 1-6), A+(B.136)+(S 1-6), A+(B.137)+(S 1-6), A+(B.138)+(S 1-6), A+(B.139)+(S 1-6), A+(B.140)+(S 1-6), A+(B.141)+(S 1-6), A+(B.142)+(S 1-6), A+(B.143)+(S 1-6), A+(B.144)+(S 1-6), A+(B.145)+(S 1-6), A+(B.146)+(S 1-6), A+(B.147)+(S 1-6), A+(B.148)+(S 1-6), A+(B.149)+(S 1-6), A+(B.150)+(S 1-6), A+(B.151)+(S 1-6), A+(B.152)+(S 1-6), A+(B.153)+(S 1-6), A+(B.154)+(S 1-6), A+(B.155)+(S 1-6), A+(B.156)+(S 1-6), A+(B.157)+(S 1-6), A+(B.158)+(S 1-6), A+(B.159)+(S 1-6), A+(B.160)+(S 1-6), A+(B.161)+(S 1-6), A+(B.162)+(S 1-6), A+(B.163)+(S 1-6), A+(B.164)+(S 1-6), A+(B.165)+(S 1-6), A+(B.166)+(S 1-6), A+(B.167)+(S 1-6), A+(B.168)+(S 1-6), A+(B.169)+(S 1-6), A+(B.170)+(S 1-6), A+(B.171)+(S 1-6), A+(B.172)+(S 1-6), A+(B.173)+(S 1-6), A+(B.174)+(S 1-6), A+(B.175)+(S 1-6), A+(B.176)+(S 1-6), A+(B.177)+(S 1-6), A+(B.178)+(S 1-6), A+(B.179)+(S 1-6), A+(B.180)+(S 1-6), A+(B.181)+(S 1-6), A+(B.182)+(S 1-6), A+(B.183)+(S 1-6), A+(B.184)+(S 1-6), A+(B.185)+(S 1-6), A+(B.186)+(S 1-6), A+(B.187)+(S 1-6), A+(B.188)+(S 1-6), A+(B.189)+(S 1-6), A+(B.190)+(S 1-6), A+(B.191)+(S 1-6), A+(B.192)+(S 1-6), A+(B.193)+(S 1-6), A+(B.194)+(S 1-6), A+(B.195)+(S 1-6), A+(B.196)+(S 1-6), A+(B.197)+(S 1-6), A+(B.198)+(S 1-6), A+(B.199)+(S 1-6), A+(B.200)+(S 1-6), A+(B.201)+(S 1-6), A+(B.202)+(S 1-6), A+(B.203)+(S 1-6), A+(B.204)+(S 1-6), A+(B.205)+(S 1-6), A+(B.206)+(S 1-6), A+(B.207)+(S 1-6), A+(B.208)+(S 1-6), A+(B.209)+(S 1-6), A+(B.210)+(S 1-6), A+(B.211)+(S 1-6), A+(B.212)+(S 1-6), A+(B.213)+(S 1-6), A+(B.214)+(S 1-6), A+(B.215)+(S 1-6), A+(B.216)+(S 1-6), A+(B.217)+(S 1-6), A+(B.218)+(S 1-6), A+(B.219)+(S 1-6), A+(B.220)+(S 1-6), A+(B.221)+(S 1-6), A+(B.222)+(S 1-6), A+(B.223)+(S 1-6), A+(B.224)+(S 1-6), A+(B.225)+(S 1-6), A+(B.226)+(S 1-6), A+(B.227)+(S 1-6), A+(B.228)+(S 1-6), A+(B.229)+(S 1-6), A+(B.230)+(S 1-6), A+(B.231)+(S 1-6), A+(B.232)+(S 1-6), A+(B.233)+(S 1-6), A+(B.234)+(S 1-6), A+(B.235)+(S 1-6), A+(B.236)+(S 1-6), A+(B.237)+(S 1-6), A+(B.238)+(S 1-6), A+(B.239)+(S 1-6), A+(B.240)+(S 1-6), A+(B.241)+(S 1-6), A+(B.242)+(S 1-6), A+(B.243)+(S 1-6), A+(B.244)+(S 1-6), A+(B.245)+(S 1-6), A+(B.246)+(S 1-6), A+(B.247)+(S 1-6), A+(B.248)+(S 1-6), A+(B.249)+(S 1-6), A+(B.250)+(S 1-6), A+(B.251)+(S 1-6), A+(B.252)+(S 1-6), A+(B.253)+(S 1-6), A+(B.254)+(S 1-6), A+(B.255)+(S 1-6), A+(B.256)+(S 1-6), A+(B.257)+(S 1-6), A+(B.258)+(S 1-6), A+(B.259)+(S 1-6), A+(B.260)+(S 1-6), A+(B.261)+(S 1-6), A+(B.262)+(S 1-6), A+(B.263)+(S 1-6), A+(B.264)+(S 1-6), A+(B.265)+(S 1-6), A+(B.266)+(S 1-6), A+(B.267)+(S 1-6), A+(B.268)+(S 1-6), A+(B.269)+(S 1-6), A+(B.270)+(S 1-6), A+(B.271)+(S 1-6), A+(B.272)+(S 1-6), A+(B.273)+(S 1-6), A+(B.274)+(S 1-6), A+(B.275)+(S 1-6), A+(B.276)+(S 1-6), A+(B.277)+(S 1-6), A+(B.278)+(S 1-6), A+(B.279)+(S 1-6), A+(B.280)+(S 1-6).

As particularly suitable compositions, particular emphasis may be given to the following two-way combinations with safener (S 1-9) (compound of the formula (I)=A):

A+(S 1-9), A+(B.1)+(S 1-9), A+(B.2)+(S 1-9), A+(B.3)+(S 1-9), A+(B.4)+(S 1-9), A+(B.5)+(S 1-9), A+(B.6)+(S 1-9), A+(B.7)+(S 1-9), A+(B.8)+(S 1-9), A+(B.9)+(S 1-9), A+(B.10)+(S 1-9), A+(B.11)+(S 1-9), A+(B.12)+(S 1-9), A+(B.13)+(S 1-9), A+(B.14)+(S 1-9), A+(B.15)+(S 1-9), A+(B.16)+(S 1-9), A+(B.17)+(S 1-9), A+(B.18)+(S 1-9), A+(B.19)+(S 1-9), A+(B.20)+(S 1-9), A+(B.21)+(S 1-9), A+(B.22)+(S 1-9), A+(B.23)+(S 1-9), A+(B.24)+(S 1-9), A+(B.25)+(S 1-9), A+(B.26)+(S 1-9), A+(B.27)+(S 1-9), A+(B.28)+(S 1-9), A+(B.29)+(S 1-9), A+(B.30)+(S 1-9), A+(B.31)+(S 1-9), A+(B.32)+(S 1-9), A+(B.33)+(S 1-9), A+(B.34)+(S 1-9), A+(B.35)+(S 1-9), A+(B.36)+(S 1-9), A+(B.37)+(S 1-9), A+(B.38)+(S 1-9), A+(B.39)+(S 1-9), A+(B.40)+(S 1-9), A+(B.41)+(S 1-9), A+(B.42)+(S 1-9), A+(B.43)+(S 1-9), A+(B.44)+(S 1-9), A+(B.45)+(S 1-9), A+(B.46)+(S 1-9), A+(B.47)+(S 1-9), A+(B.48)+(S 1-9), A+(B.49)+(S 1-9), A+(B.50)+(S 1-9), A+(B.51)+(S 1-9), A+(B.52)+(S 1-9), A+(B.53)+(S 1-9), A+(B.54)+(S 1-9), A+(B.55)+(S 1-9), A+(B.56)+(S 1-9), A+(B.57)+(S 1-9), A+(B.58)+(S 1-9), A+(B.59)+(S 1-9), A+(B.60)+(S 1-9), A+(B.61)+(S 1-9), A+(B.62)+(S 1-9), A+(B.63)+(S 1-9), A+(B.64)+(S 1-9), A+(B.65)+(S 1-9), A+(B.66)+(S 1-9), A+(B.67)+(S 1-9), A+(B.68)+(S 1-9), A+(B.69)+(S 1-9), A+(B.70)+(S 1-9), A+(B.71)+(S 1-9), A+(B.72)+(S 1-9), A+(B.73)+(S 1-9), A+(B.74)+(S 1-9), A+(B.75)+(S 1-9), A+(B.76)+(S 1-9), A+(B.77)+(S 1-9), A+(B.78)+(S 1-9), A+(B.79)+(S 1-9), A+(B.80)+(S 1-9), A+(B.81)+(S 1-9), A+(B.82)+(S 1-9), A+(B.83)+(S 1-9), A+(B.84)+(S 1-9), A+(B.85)+(S 1-9), A+(B.86)+(S 1-9), A+(B.87)+(S 1-9), A+(B.88)+(S 1-9), A+(B.89)+(S 1-9), A+(B.90)+(S 1-9), A+(B.91)+(S 1-9), A+(B.92)+(S 1-9), A+(B.93)+(S 1-9), A+(B.94)+(S 1-9), A+(B.95)+(S 1-9), A+(B.96)+(S 1-9), A+(B.97)+(S 1-9), A+(B.98)+(S 1-9), A+(B.99)+(S 1-9), A+(B.100)+(S 1-9), A+(B.101)+(S 1-9), A+(B.102)+(S 1-9), A+(B.103)+(S 1-9), A+(B.104)+(S 1-9), A+(B.105)+(S 1-9), A+(B.106)+(S 1-9), A+(B.107)+(S 1-9), A+(B.108)+(S 1-9), A+(B.109)+(S 1-9), A+(B.110)+(S 1-9), A+(B.111)+(S 1-9), A+(B.112)+(S 1-9), A+(B.113)+(S 1-9), A+(B.114)+(S 1-9), A+(B.115)+(S 1-9), A+(B.116)+(S 1-9), A+(B.117)+(S 1-9), A+(B.118)+(S 1-9), A+(B.119)+(S 1-9), A+(B.120)+(S 1-9), A+(B.121)+(S 1-9), A+(B.122)+(S 1-9), A+(B.123)+(S 1-9), A+(B.124)+(S 1-9), A+(B.125)+(S 1-9), A+(B.126)+(S 1-9), A+(B.127)+(S 1-9), A+(B.128)+(S 1-9), A+(B.129)+(S 1-9), A+(B.130)+(S 1-9), A+(B.131)+(S 1-9), A+(B.132)+(S 1-9), A+(B.133)+(S 1-9), A+(B.134)+(S 1-9), A+(B.135)+(S 1-9), A+(B.136)+(S 1-9), A+(B.137)+(S 1-9), A+(B.138)+(S 1-9), A+(B.139)+(S 1-9), A+(B.140)+(S 1-9), A+(B.141)+(S 1-9), A+(B.142)+(S 1-9), A+(B.143)+(S 1-9), A+(B.144)+(S 1-9), A+(B.145)+(S 1-9), A+(B.146)+(S 1-9), A+(B.147)+(S 1-9), A+(B.148)+(S 1-9), A+(B.149)+(S 1-9), A+(B.150)+(S 1-9), A+(B.151)+(S 1-9), A+(B.152)+(S 1-9), A+(B.153)+(S 1-9), A+(B.154)+(S 1-9), A+(B.155)+(S 1-9), A+(B.156)+(S 1-9), A+(B.157)+(S 1-9), A+(B.158)+(S 1-9), A+(B.159)+(S 1-9), A+(B.160)+(S 1-9), A+(B.161)+(S 1-9), A+(B.162)+(S 1-9), A+(B.163)+(S 1-9), A+(B.164)+(S 1-9), A+(B.165)+(S 1-9), A+(B.166)+(S 1-9), A+(B.167)+(S 1-9), A+(B.168)+(S 1-9), A+(B.169)+(S 1-9), A+(B.170)+(S 1-9), A+(B.171)+(S 1-9), A+(B.172)+(S 1-9), A+(B.173)+(S 1-9), A+(B.174)+(S 1-9), A+(B.175)+(S 1-9), A+(B.176)+(S 1-9), A+(B.177)+(S 1-9), A+(B.178)+(S 1-9), A+(B.179)+(S 1-9), A+(B.180)+(S 1-9), A+(B.181)+(S 1-9), A+(B.182)+(S 1-9), A+(B.183)+(S 1-9), A+(B.184)+(S 1-9), A+(B.185)+(S 1-9), A+(B.186)+(S 1-9), A+(B.187)+(S 1-9), A+(B.188)+(S 1-9), A+(B.189)+(S 1-9), A+(B.190)+(S 1-9), A+(B.191)+(S 1-9), A+(B.192)+(S 1-9), A+(B.193)+(S 1-9), A+(B.194)+(S 1-9), A+(B.195)+(S 1-9), A+(B.196)+(S 1-9), A+(B.197)+(S 1-9), A+(B.198)+(S 1-9), A+(B.199)+(S 1-9), A+(B.200)+(S 1-9), A+(B.201)+(S 1-9), A+(B.202)+(S 1-9), A+(B.203)+(S 1-9), A+(B.204)+(S 1-9), A+(B.205)+(S 1-9), A+(B.206)+(S 1-9), A+(B.207)+(S 1-9), A+(B.208)+(S 1-9), A+(B.209)+(S 1-9), A+(B.210)+(S 1-9), A+(B.211)+(S 1-9), A+(B.212)+(S 1-9), A+(B.213)+(S 1-9), A+(B.214)+(S 1-9), A+(B.215)+(S 1-9), A+(B.216)+(S 1-9), A+(B.217)+(S 1-9), A+(B.218)+(S 1-9), A+(B.219)+(S 1-9), A+(B.220)+(S 1-9), A+(B.221)+(S 1-9), A+(B.222)+(S 1-9), A+(B.223)+(S 1-9), A+(B.224)+(S 1-9), A+(B.225)+(S 1-9), A+(B.226)+(S 1-9), A+(B.227)+(S 1-9), A+(B.228)+(S 1-9), A+(B.229)+(S 1-9), A+(B.230)+(S 1-9), A+(B.231)+(S 1-9), A+(B.232)+(S 1-9), A+(B.233)+(S 1-9), A+(B.234)+(S 1-9), A+(B.235)+(S 1-9), A+(B.236)+(S 1-9), A+(B.237)+(S 1-9), A+(B.238)+(S 1-9), A+(B.239)+(S 1-9), A+(B.240)+(S 1-9), A+(B.241)+(S 1-9), A+(B.242)+(S 1-9), A+(B.243)+(S 1-9), A+(B.244)+(S 1-9), A+(B.245)+(S 1-9), A+(B.246)+(S 1-9), A+(B.247)+(S 1-9), A+(B.248)+(S 1-9), A+(B.249)+(S 1-9), A+(B.250)+(S 1-9), A+(B.251)+(S 1-9), A+(B.252)+(S 1-9), A+(B.253)+(S 1-9), A+(B.254)+(S 1-9), A+(B.255)+(S 1-9), A+(B.256)+(S 1-9), A+(B.257)+(S 1-9), A+(B.258)+(S 1-9), A+(B.259)+(S 1-9), A+(B.260)+(S 1-9), A+(B.261)+(S 1-9), A+(B.262)+(S 1-9), A+(B.263)+(S 1-9), A+(B.264)+(S 1-9), A+(B.265)+(S 1-9), A+(B.266)+(S 1-9), A+(B.267)+(S 1-9), A+(B.268)+(S 1-9), A+(B.269)+(S 1-9), A+(B.270)+(S 1-9), A+(B.271)+(S 1-9), A+(B.272)+(S 1-9), A+(B.273)+(S 1-9), A+(B.274)+(S 1-9), A+(B.275)+(S 1-9), A+(B.276)+(S 1-9), A+(B.277)+(S 1-9), A+(B.278)+(S 1-9), A+(B.279)+(S 1-9), A+(B.280)+(S 1-9).

As particularly suitable compositions, particular emphasis may be given to the following two-way combinations with safener (S 2-1) (compound of the formula (I)=A):

A+(S 2-1), A+(B.1)+(S 2-1), A+(B.2)+(S 2-1), A+(B.3)+(S 2-1), A+(B.4)+(S 2-1), A+(B.5)+(S 2-1), A+(B.6)+(S 2-1), A+(B.7)+(S 2-1), A+(B.8)+(S 2-1), A+(B.9)+(S 2-1), A+(B.10)+(S 2-1), A+(B.11)+(S 2-1), A+(B.12)+(S 2-1), A+(B.13)+(S 2-1), A+(B.14)+(S 2-1), A+(B.15)+(S 2-1), A+(B.16)+(S 2-1), A+(B.17)+(S 2-1), A+(B.18)+(S 2-1), A+(B.19)+(S 2-1), A+(B.20)+(S 2-1), A+(B.21)+(S 2-1), A+(B.22)+(S 2-1), A+(B.23)+(S 2-1), A+(B.24)+(S 2-1), A+(B.25)+(S 2-1), A+(B.26)+(S 2-1), A+(B.27)+(S 2-1), A+(B.28)+(S 2-1), A+(B.29)+(S 2-1), A+(B.30)+(S 2-1), A+(B.31)+(S 2-1), A+(B.32)+(S 2-1), A+(B.33)+(S 2-1), A+(B.34)+(S 2-1), A+(B.35)+(S 2-1), A+(B.36)+(S 2-1), A+(B.37)+(S 2-1), A+(B.38)+(S 2-1), A+(B.39)+(S 2-1), A+(B.40)+(S 2-1), A+(B.41)+(S 2-1), A+(B.42)+(S 2-1), A+(B.43)+(S 2-1), A+(B.44)+(S 2-1), A+(B.45)+(S 2-1), A+(B.46)+(S 2-1), A+(B.47)+(S 2-1), A+(B.48)+(S 2-1), A+(B.49)+(S 2-1), A+(B.50)+(S 2-1), A+(B.51)+(S 2-1), A+(B.52)+(S 2-1), A+(B.53)+(S 2-1), A+(B.54)+(S 2-1), A+(B.55)+(S 2-1), A+(B.56)+(S 2-1), A+(B.57)+(S 2-1), A+(B.58)+(S 2-1), A+(B.59)+(S 2-1), A+(B.60)+(S 2-1), A+(B.61)+(S 2-1), A+(B.62)+(S 2-1), A+(B.63)+(S 2-1), A+(B.64)+(S 2-1), A+(B.65)+(S 2-1), A+(B.66)+(S 2-1), A+(B.67)+(S 2-1), A+(B.68)+(S 2-1), A+(B.69)+(S 2-1), A+(B.70)+(S 2-1), A+(B.71)+(S 2-1), A+(B.72)+(S 2-1), A+(B.73)+(S 2-1), A+(B.74)+(S 2-1), A+(B.75)+(S 2-1), A+(B.76)+(S 2-1), A+(B.77)+(S 2-1), A+(B.78)+(S 2-1), A+(B.79)+(S 2-1), A+(B.80)+(S 2-1), A+(B.81)+(S 2-1), A+(B.82)+(S 2-1), A+(B.83)+(S 2-1), A+(B.84)+(S 2-1), A+(B.85)+(S 2-1), A+(B.86)+(S 2-1), A+(B.87)+(S 2-1), A+(B.88)+(S 2-1), A+(B.89)+(S 2-1), A+(B.90)+(S 2-1), A+(B.91)+(S 2-1), A+(B.92)+(S 2-1), A+(B.93)+(S 2-1), A+(B.94)+(S 2-1), A+(B.95)+(S 2-1), A+(B.96)+(S 2-1), A+(B.97)+(S 2-1), A+(B.98)+(S 2-1), A+(B.99)+(S 2-1), A+(B.100)+(S 2-1), A+(B.101)+(S 2-1), A+(B.102)+(S 2-1), A+(B.103)+(S 2-1), A+(B.104)+(S 2-1), A+(B.105)+(S 2-1), A+(B.106)+(S 2-1), A+(B.107)+(S 2-1), A+(B.108)+(S 2-1), A+(B.109)+(S 2-1), A+(B.110)+(S 2-1), A+(B.111)+(S 2-1), A+(B.112)+(S 2-1), A+(B.113)+(S 2-1), A+(B.114)+(S 2-1), A+(B.115)+(S 2-1), A+(B.116)+(S 2-1), A+(B.117)+(S 2-1), A+(B.118)+(S 2-1), A+(B.119)+(S 2-1), A+(B.120)+(S 2-1), A+(B.121)+(S 2-1), A+(B.122)+(S 2-1), A+(B.123)+(S 2-1), A+(B.124)+(S 2-1), A+(B.125)+(S 2-1), A+(B.126)+(S 2-1), A+(B.127)+(S 2-1), A+(B.128)+(S 2-1), A+(B.129)+(S 2-1), A+(B.130)+(S 2-1), A+(B.131)+(S 2-1), A+(B.132)+(S 2-1), A+(B.133)+(S 2-1), A+(B.134)+(S 2-1), A+(B.135)+(S 2-1), A+(B.136)+(S 2-1), A+(B.137)+(S 2-1), A+(B.138)+(S 2-1), A+(B.139)+(S 2-1), A+(B.140)+(S 2-1), A+(B.141)+(S 2-1), A+(B.142)+(S 2-1), A+(B.143)+(S 2-1), A+(B.144)+(S 2-1), A+(B.145)+(S 2-1), A+(B.146)+(S 2-1), A+(B.147)+(S 2-1), A+(B.148)+(S 2-1), A+(B.149)+(S 2-1), A+(B.150)+(S 2-1), A+(B.151)+(S 2-1), A+(B.152)+(S 2-1), A+(B.153)+(S 2-1), A+(B.154)+(S 2-1), A+(B.155)+(S 2-1), A+(B.156)+(S 2-1), A+(B.157)+(S 2-1), A+(B.158)+(S 2-1), A+(B.159)+(S 2-1), A+(B.160)+(S 2-1), A+(B.161)+(S 2-1), A+(B.162)+(S 2-1), A+(B.163)+(S 2-1), A+(B.164)+(S 2-1), A+(B.165)+(S 2-1), A+(B.166)+(S 2-1), A+(B.167)+(S 2-1), A+(B.168)+(S 2-1), A+(B.169)+(S 2-1), A+(B.170)+(S 2-1), A+(B.171)+(S 2-1), A+(B.172)+(S 2-1), A+(B.173)+(S 2-1), A+(B.174)+(S 2-1), A+(B.175)+(S 2-1), A+(B.176)+(S 2-1), A+(B.177)+(S 2-1), A+(B.178)+(S 2-1), A+(B.179)+(S 2-1), A+(B.180)+(S 2-1), A+(B.181)+(S 2-1), A+(B.182)+(S 2-1), A+(B.183)+(S 2-1), A+(B.184)+(S 2-1), A+(B.185)+(S 2-1), A+(B.186)+(S 2-1), A+(B.187)+(S 2-1), A+(B.188)+(S 2-1), A+(B.189)+(S 2-1), A+(B.190)+(S 2-1), A+(B.191)+(S 2-1), A+(B.192)+(S 2-1), A+(B.193)+(S 2-1), A+(B.194)+(S 2-1), A+(B.195)+(S 2-1), A+(B.196)+(S 2-1), A+(B.197)+(S 2-1), A+(B.198)+(S 2-1), A+(B.199)+(S 2-1), A+(B.200)+(S 2-1), A+(B.201)+(S 2-1), A+(B.202)+(S 2-1), A+(B.203)+(S 2-1), A+(B.204)+(S 2-1), A+(B.205)+(S 2-1), A+(B.206)+(S 2-1), A+(B.207)+(S 2-1), A+(B.208)+(S 2-1), A+(B.209)+(S 2-1), A+(B.210)+(S 2-1), A+(B.211)+(S 2-1), A+(B.212)+(S 2-1), A+(B.213)+(S 2-1), A+(B.214)+(S 2-1), A+(B.215)+(S 2-1), A+(B.216)+(S 2-1), A+(B.217)+(S 2-1), A+(B.218)+(S 2-1), A+(B.219)+(S 2-1), A+(B.220)+(S 2-1), A+(B.221)+(S 2-1), A+(B.222)+(S 2-1), A+(B.223)+(S 2-1), A+(B.224)+(S 2-1), A+(B.225)+(S 2-1), A+(B.226)+(S 2-1), A+(B.227)+(S 2-1), A+(B.228)+(S 2-1), A+(B.229)+(S 2-1), A+(B.230)+(S 2-1), A+(B.231)+(S 2-1), A+(B.232)+(S 2-1), A+(B.233)+(S 2-1), A+(B.234)+(S 2-1), A+(B.235)+(S 2-1), A+(B.236)+(S 2-1), A+(B.237)+(S 2-1), A+(B.238)+(S 2-1), A+(B.239)+(S 2-1), A+(B.240)+(S 2-1), A+(B.241)+(S 2-1), A+(B.242)+(S 2-1), A+(B.243)+(S 2-1), A+(B.244)+(S 2-1), A+(B.245)+(S 2-1), A+(B.246)+(S 2-1), A+(B.247)+(S 2-1), A+(B.248)+(S 2-1), A+(B.249)+(S 2-1), A+(B.250)+(S 2-1), A+(B.251)+(S 2-1), A+(B.252)+(S 2-1), A+(B.253)+(S 2-1), A+(B.254)+(S 2-1), A+(B.255)+(S 2-1), A+(B.256)+(S 2-1), A+(B.257)+(S 2-1), A+(B.258)+(S 2-1), A+(B.259)+(S 2-1), A+(B.260)+(S 2-1), A+(B.261)+(S 2-1), A+(B.262)+(S 2-1), A+(B.263)+(S 2-1), A+(B.264)+(S 2-1), A+(B.265)+(S 2-1), A+(B.266)+(S 2-1), A+(B.267)+(S 2-1), A+(B.268)+(S 2-1), A+(B.269)+(S 2-1), A+(B.270)+(S 2-1), A+(B.271)+(S 2-1), A+(B.272)+(S 2-1), A+(B.273)+(S 2-1), A+(B.274)+(S 2-1), A+(B.275)+(S 2-1), A+(B.276)+(S 2-1), A+(B.277)+(S 2-1), A+(B.278)+(S 2-1), A+(B.279)+(S 2-1), A+(B.280)+(S 2-1).

As particularly suitable compositions, particular emphasis may be given to the following two-way combinations with safener (S 3-1) (compound of the formula (I)=A):

A+(S 3-1), A+(B.1)+(S 3-1), A+(B.2)+(S 3-1), A+(B.3)+(S 3-1), A+(B.4)+(S 3-1), A+(B.5)+(S 3-1), A+(B.6)+(S 3-1), A+(B.7)+(S 3-1), A+(B.8)+(S 3-1), A+(B.9)+(S 3-1), A+(B.10)+(S 3-1), A+(B.11)+(S 3-1), A+(B.12)+(S 3-1), A+(B.13)+(S 3-1), A+(B.14)+(S 3-1), A+(B.15)+(S 3-1), A+(B.16)+(S 3-1), A+(B.17)+(S 3-1), A+(B.18)+(S 3-1), A+(B.19)+(S 3-1), A+(B.20)+(S 3-1), A+(B.21)+(S 3-1), A+(B.22)+(S 3-1), A+(B.23)+(S 3-1), A+(B.24)+(S 3-1), A+(B.25)+(S 3-1), A+(B.26)+(S 3-1), A+(B.27)+(S 3-1), A+(B.28)+(S 3-1), A+(B.29)+(S 3-1), A+(B.30)+(S 3-1), A+(B.31)+(S 3-1), A+(B.32)+(S 3-1), A+(B.33)+(S 3-1), A+(B.34)+(S 3-1), A+(B.35)+(S 3-1), A+(B.36)+(S 3-1), A+(B.37)+(S 3-1), A+(B.38)+(S 3-1), A+(B.39)+(S 3-1), A+(B.40)+(S 3-1), A+(B.41)+(S 3-1), A+(B.42)+(S 3-1), A+(B.43)+(S 3-1), A+(B.44)+(S 3-1), A+(B.45)+(S 3-1), A+(B.46)+(S 3-1), A+(B.47)+(S 3-1), A+(B.48)+(S 3-1), A+(B.49)+(S 3-1), A+(B.50)+(S 3-1), A+(B.51)+(S 3-1), A+(B.52)+(S 3-1), A+(B.53)+(S 3-1), A+(B.54)+(S 3-1), A+(B.55)+(S 3-1), A+(B.56)+(S 3-1), A+(B.57)+(S 3-1), A+(B.58)+(S 3-1), A+(B.59)+(S 3-1), A+(B.60)+(S 3-1), A+(B.61)+(S 3-1), A+(B.62)+(S 3-1), A+(B.63)+(S 3-1), A+(B.64)+(S 3-1), A+(B.65)+(S 3-1), A+(B.66)+(S 3-1), A+(B.67)+(S 3-1), A+(B.68)+(S 3-1), A+(B.69)+(S 3-1), A+(B.70)+(S 3-1), A+(B.71)+(S 3-1), A+(B.72)+(S 3-1), A+(B.73)+(S 3-1), A+(B.74)+(S 3-1), A+(B.75)+(S 3-1), A+(B.76)+(S 3-1), A+(B.77)+(S 3-1), A+(B.78)+(S 3-1), A+(B.79)+(S 3-1), A+(B.80)+(S 3-1), A+(B.81)+(S 3-1), A+(B.82)+(S 3-1), A+(B.83)+(S 3-1), A+(B.84)+(S 3-1), A+(B.85)+(S 3-1), A+(B.86)+(S 3-1), A+(B.87)+(S 3-1), A+(B.88)+(S 3-1), A+(B.89)+(S 3-1), A+(B.90)+(S 3-1), A+(B.91)+(S 3-1), A+(B.92)+(S 3-1), A+(B.93)+(S 3-1), A+(B.94)+(S 3-1), A+(B.95)+(S 3-1), A+(B.96)+(S 3-1), A+(B.97)+(S 3-1), A+(B.98)+(S 3-1), A+(B.99)+(S 3-1), A+(B.100)+(S 3-1), A+(B.101)+(S 3-1), A+(B.102)+(S 3-1), A+(B.103)+(S 3-1), A+(B.104)+(S 3-1), A+(B.105)+(S 3-1), A+(B.106)+(S 3-1), A+(B.107)+(S 3-1), A+(B.108)+(S 3-1), A+(B.109)+(S 3-1), A+(B.110)+(S 3-1), A+(B.111)+(S 3-1), A+(B.112)+(S 3-1), A+(B.113)+(S 3-1), A+(B.114)+(S 3-1), A+(B.115)+(S 3-1), A+(B.116)+(S 3-1), A+(B.117)+(S 3-1), A+(B.118)+(S 3-1), A+(B.119)+(S 3-1), A+(B.120)+(S 3-1), A+(B.121)+(S 3-1), A+(B.122)+(S 3-1), A+(B.123)+(S 3-1), A+(B.124)+(S 3-1), A+(B.125)+(S 3-1), A+(B.126)+(S 3-1), A+(B.127)+(S 3-1), A+(B.128)+(S 3-1), A+(B.129)+(S 3-1), A+(B.130)+(S 3-1), A+(B.131)+(S 3-1), A+(B.132)+(S 3-1), A+(B.133)+(S 3-1), A+(B.134)+(S 3-1), A+(B.135)+(S 3-1), A+(B.136)+(S 3-1), A+(B.137)+(S 3-1), A+(B.138)+(S 3-1), A+(B.139)+(S 3-1), A+(B.140)+(S 3-1), A+(B.141)+(S 3-1), A+(B.142)+(S 3-1), A+(B.143)+(S 3-1), A+(B.144)+(S 3-1), A+(B.145)+(S 3-1), A+(B.146)+(S 3-1), A+(B.147)+(S 3-1), A+(B.148)+(S 3-1), A+(B.149)+(S 3-1), A+(B.150)+(S 3-1), A+(B.151)+(S 3-1), A+(B.152)+(S 3-1), A+(B.153)+(S 3-1), A+(B.154)+(S 3-1), A+(B.155)+(S 3-1), A+(B.156)+(S 3-1), A+(B.157)+(S 3-1), A+(B.158)+(S 3-1), A+(B.159)+(S 3-1), A+(B.160)+(S 3-1), A+(B.161)+(S 3-1), A+(B.162)+(S 3-1), A+(B.163)+(S 3-1), A+(B.164)+(S 3-1), A+(B.165)+(S 3-1), A+(B.166)+(S 3-1), A+(B.167)+(S 3-1), A+(B.168)+(S 3-1), A+(B.169)+(S 3-1), A+(B.170)+(S 3-1), A+(B.171)+(S 3-1), A+(B.172)+(S 3-1), A+(B.173)+(S 3-1), A+(B.174)+(S 3-1), A+(B.175)+(S 3-1), A+(B.176)+(S 3-1), A+(B.177)+(S 3-1), A+(B.178)+(S 3-1), A+(B.179)+(S 3-1), A+(B.180)+(S 3-1), A+(B.181)+(S 3-1), A+(B.182)+(S 3-1), A+(B.183)+(S 3-1), A+(B.184)+(S 3-1), A+(B.185)+(S 3-1), A+(B.186)+(S 3-1), A+(B.187)+(S 3-1), A+(B.188)+(S 3-1), A+(B.189)+(S 3-1), A+(B.190)+(S 3-1), A+(B.191)+(S 3-1), A+(B.192)+(S 3-1), A+(B.193)+(S 3-1), A+(B.194)+(S 3-1), A+(B.195)+(S 3-1), A+(B.196)+(S 3-1), A+(B.197)+(S 3-1), A+(B.198)+(S 3-1), A+(B.199)+(S 3-1), A+(B.200)+(S 3-1), A+(B.201)+(S 3-1), A+(B.202)+(S 3-1), A+(B.203)+(S 3-1), A+(B.204)+(S 3-1), A+(B.205)+(S 3-1), A+(B.206)+(S 3-1), A+(B.207)+(S 3-1), A+(B.208)+(S 3-1), A+(B.209)+(S 3-1), A+(B.210)+(S 3-1), A+(B.211)+(S 3-1), A+(B.212)+(S 3-1), A+(B.213)+(S 3-1), A+(B.214)+(S 3-1), A+(B.215)+(S 3-1), A+(B.216)+(S 3-1), A+(B.217)+(S 3-1), A+(B.218)+(S 3-1), A+(B.219)+(S 3-1), A+(B.220)+(S 3-1), A+(B.221)+(S 3-1), A+(B.222)+(S 3-1), A+(B.223)+(S 3-1), A+(B.224)+(S 3-1), A+(B.225)+(S 3-1), A+(B.226)+(S 3-1), A+(B.227)+(S 3-1), A+(B.228)+(S 3-1), A+(B.229)+(S 3-1), A+(B.230)+(S 3-1), A+(B.231)+(S 3-1), A+(B.232)+(S 3-1), A+(B.233)+(S 3-1), A+(B.234)+(S 3-1), A+(B.235)+(S 3-1), A+(B.236)+(S 3-1), A+(B.237)+(S 3-1), A+(B.238)+(S 3-1), A+(B.239)+(S 3-1), A+(B.240)+(S 3-1), A+(B.241)+(S 3-1), A+(B.242)+(S 3-1), A+(B.243)+(S 3-1), A+(B.244)+(S 3-1), A+(B.245)+(S 3-1), A+(B.246)+(S 3-1), A+(B.247)+(S 3-1), A+(B.248)+(S 3-1), A+(B.249)+(S 3-1), A+(B.250)+(S 3-1), A+(B.251)+(S 3-1), A+(B.252)+(S 3-1), A+(B.253)+(S 3-1), A+(B.254)+(S 3-1), A+(B.255)+(S 3-1), A+(B.256)+(S 3-1), A+(B.257)+(S 3-1), A+(B.258)+(S 3-1), A+(B.259)+(S 3-1), A+(B.260)+(S 3-1), A+(B.261)+(S 3-1), A+(B.262)+(S 3-1), A+(B.263)+(S 3-1), A+(B.264)+(S 3-1), A+(B.265)+(S 3-1), A+(B.266)+(S 3-1), A+(B.267)+(S 3-1), A+(B.268)+(S 3-1), A+(B.269)+(S 3-1), A+(B.270)+(S 3-1), A+(B.271)+(S 3-1), A+(B.272)+(S 3-1), A+(B.273)+(S 3-1), A+(B.274)+(S 3-1), A+(B.275)+(S 3-1), A+(B.276)+(S 3-1), A+(B.277)+(S 3-1), A+(B.278)+(S 3-1), A+(B.279)+(S 3-1), A+(B.280)+(S 3-1).

In all of the two-way combinations listed explicitly above, with and without addition of safener, the compound of the formula (I) can also be replaced by its salts, preferably its sodium salt of the formula (Ia).

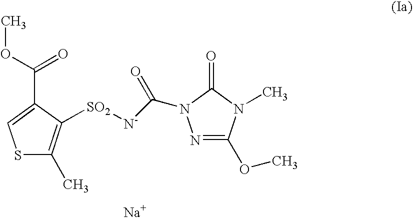

These mixtures in some cases have advantages, moreover, which are manifested in improved properties of the active ingredient formulation, such as activity or storage stability, for example.

Among all of the stated mixtures, emphasis may be given to those in which the co-component is selected from the following group of co-components:

acetochlor, aclonifen, alachlor, amidosulfuron, atrazine, bromoxynil, bromoxynyl-heptanoate, bromoxynil-octanoate, bromoxynil-potassium, chlorsulfuron, clodinafop-propargyl, 2,4-D and its salts, amines, and esters, difenzoquat, diflufenican, dimethenamid, dimthenamid-P, ethoxysulfuron and its sodium salt, flufenacet, flupyrsulfuron-methyl and its sodium salt, foramsulfuron, glufosinate, glufosinate-ammonium, glyphosate, glyphosate-ammonium, glyphosate-isopropylammonium, glyphosate-sodium, glyphosate-trimesium, imazamethabenz-methyl, imazapic, iodosulfuron-methyl-sodium, isoxaflutole, MCPA, mesotrione, metolachlor, S-metolachlor, mesosulfuron-methyl and its sodium salt, nicosulfuron, pendimethalin, picolinafen, prosulfuron, sulcotrione, sulfosulfuron, terbuthylazine, tralkoxydim, and triasulfuron.

Maximum emphasis may be given to the combination A+pinoxaden or A=pinoxaden+cloquintocet-mexyl. A herbicidal composition composed of an active ingredient combination comprising the compound A and pinoxaden and also, where appropriate, the safener cloquintocet-mexyl is especially suitable in the method of the invention and also for controlling Avena species.

Where the compositions have not already been specifically disclosed in WO 03/026426, all herbicidal compositions comprising the abovementioned active ingredient combinations are likewise provided by the present specification.

The active ingredients in the active ingredient combinations listed explicitly above can be used in combination (e.g., as a tank mix), or else sequentially before sowing, preemergence (after sowing), postemergence (1-2-leaf stage), postemergence (24-leaf stage), and postemergence (6-leaf stage), thus producing, for example, the following generalized application scheme:

| Application of | | Pre- | Post- | Post- | Post- |
|---|---|---|---|---|---|
| active | Before | emergence | emergence | emergence | emergence |
| ingredients | sowing | (after sowing) | (1-2-leaf) | (2-4-leaf) | (6-leaf) |
| in combination | A + (B) | | | | |
| in combination | | A + (B) | | | |
| in combination | | | A + (B) | | |
| in combination | | | | A + (B) | |
| in combination | | | | | A + (B) |
| sequentially | A + (B) | A + (B) | | | |
| sequentially | | A + (B) | A + (B) | | |
| sequentially | | (B) | | (A) | |
| sequentially | | (B) | | A + (B) | |
| sequentially | | | A + (B) | A + (B) | |
| sequentially | | | A + (B) | A + (B) | A + (B) |
| sequentially | (B) | | (A) | A + (B) | |
| sequentially | | (B) | | A + (B) | A + (B) |
| sequentially | | | | A + (B) | A + (B) |
| sequentially | | | (A) | A + (B) | A + (B) |

As already mentioned above, it is possible to use the compound of the formula (I) and also the above-listed combination products with the herbicidal co-components and/or safeners to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetically Modified Organisms), and parts thereof are treated. The term “parts” or “parts of plants” or “plant parts” has been explained above.

With particular preference, plants of the plant cultivars which are in each case commercially available or in use are treated according to the invention. Plant cultivars are to be understood as meaning plants having novel properties (“traits”) which have been obtained by conventional breeding, by mutagenesis or by recombinant DNA techniques. These can be cultivars, bio- or genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention—also in combination with other active agrochemical ingredients, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or proccessability of the harvested products are possible, which exceed the effects which were actually to be expected.

The preferred transgenic plants or plant cultivars (obtained by genetic engineering) which are to be treated according to the invention include all plants which, by virtue of the genetic modification, have received genetic material which imparts particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or proccessability of the harvested products. Further and particularly emphasized examples of such traits are a better defense of the plants against animal and microbial pests, such as against insects, mites, phytopathogenic fungi, bacteria and/or viruses, and also increased tolerance of the plants to certain active herbicidal ingredients. Examples of transgenic plants which may be mentioned are the important crop plants, such as cereals (wheat, rice), corn, soya, potatoes, cotton, oilseed rape and also fruit plants (with the fruits apples, pears, citrus fruits and grapes), and particular emphasis is given to corn, soya beans, potatoes, cotton and oilseed rape. Traits that are emphasized are in particular increased defense of the plants against insects by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to hereinbelow as “Bt plants”). Traits that are also particularly emphasized are the increased defense of the plants against fungi, bacteria and viruses by systemic acquired resistance (SAR), systemin, phytoalexins, elicitors and resistance genes and correspondingly expressed proteins and toxins. Traits that are additionally particularly emphasized are the increased tolerance of the plants to certain herbicidally active compounds, for example imidazolinones, sulfonylureas, glyphosate or phosphinotricin (for example the “PAT” gene). The genes which impart the desired traits in question can also be present in combination with one another in the transgenic plants. Examples of “Bt plants” which may be mentioned are corn varieties, cotton varieties, soya varieties and potato varieties which are sold under the trade names YIELD GARD® (for example corn, cotton, soya), KnockOut® (for example corn), StarLink® (for example corn), Bollgard® (cotton), Nucotn® (cotton) and NewLeaf® (potato). Examples of herbicide-tolerant plants which may be mentioned are maize varieties, cotton varieties and soya varieties which are sold under the trade names Roundup Ready® (tolerance to glyphosate, for example corn, cotton, soya), Liberty Link® (tolerance to phosphinotricin, for example oilseed rape), IMI® (tolerance to imidazolinones) and STS® (tolerance to sulfonylureas, for example corn). Herbicide-resistant plants (plants bred in a conventional manner for herbicide tolerance) which may be mentioned include the varieties sold under the name Clearfield® (for example corn). Of course, these statements also apply to plant cultivars having these genetic traits, or genetic traits still to be developed, that will be developed and/or marketed in the future.

The plants listed can be treated in a particularly advantageous manner with the compound of the formula (I), the effective control of the weed plants being further accompanied by the abovementioned synergistic effects with the transgenic plants or cultivars. The preferred ranges stated above for the active ingredients or mixtures also apply to the treatment of these plants. Particular emphasis is given to the treatment of plants with the compounds or mixtures specifically mentioned in the present text.

The compound of the formula (I) and the mixtures comprising this compound can be converted into the customary formulations, such as solutions, emulsions, wettable powders, suspensions, powders, dusts, pastes, soluble powders, granules, suspension-emulsion concentrates, natural materials impregnated with active ingredient, synthetic materials impregnated with active ingredient, and microencapsulations in polymeric substances.

These formulations are produced conventionally, such as by mixing the active ingredients with extenders, in other words liquid solvents and/or solid carriers, where appropriate with the use of surface-active agents, i.e., emulsifiers and/or dispersants and/or foam-formers.

Where the extender used includes water, it is also possible, for example, to employ organic solvents as auxiliary solvents. Suitable liquid solvents are essentially as follows: aromatic hydrocarbons such as xylene, toluene or alkylnaphthalenes, chlorinated aromatic compounds such as chlorobenzenes, chlorinated aliphatic compounds such as chloroethylenes or methylene chloride, aliphatic hydrocarbons such as cyclohexane or paraffins, petroleum fractions, mineral oils and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulfoxide, and water.

Suitable solid carriers include the following: e.g., ammonium salts and fine powders of natural minerals, such as kaolins, clays, talc, chalk, quartz, attapulgite, montmorillonite or diatomaceous earth, and fine powders of synthetic minerals, such as highly disperse silica, alumina and silicates; suitable solid carriers for granules include the following: e.g., crushed and fractionated natural minerals such as calcite, marble, pumice, sepiolite, and dolomite, and also synthetic granules of fine organic and inorganic powders, and also granules of organic material such as sawdust, coconut shells, corn cobs, and tobacco stalks; suitable emulsifiers and/or foam-formers include the following: e.g., nonionic and anionic emulsifiers, such as polyoxyethylene fatty acid esters, polyoxyethylene fatty alcohol ethers, e.g., alkylaryl polyglycol ethers, alkylsulfonates, alkyl sulfates, arylsulfonates, and protein hydrolysates; and suitable dispersants include the following: e.g., lignin sulfite waste liquors and methylcellulose.

Within the formulations it is possible to use stickers such as carboxymethylcellulose, natural and synthetic polymers in the form of powders, granules or lattices, such as gum arabic, polyvinyl alcohol, and polyvinyl acetate, and also natural phospholipids, such as cephalins and lecithins, and synthetic phospholipids. Further additives may be mineral and vegetable oils.

It is possible to use colorants such as inorganic pigments, such as iron oxide, titanium oxide and Prussian Blue, and organic dyes, such as alizarin dyes, azo dyes, and metal phthalocyanine dyes, and trace nutrients such as salts of iron, manganese, boron, copper, cobalt, molybdenum, and zinc.

The formulations generally contain between 0.1 and 95 percent by weight of active ingredient, preferably between 0.5% and 90%.

The compound of the formula (I) and its salts can be employed per se, in the form of their formulations or the application forms prepared from them by further dilution, such as ready-to-use solutions, suspensions, emulsions, powders, pastes, and granules. Application takes place in conventional manner, such as by pouring, spraying, injecting or broadcasting.

The compound of the formula (I) and its salts can be applied both before and after the emergence of plants. They can also be incorporated into the soil before sowing.

The amount of active ingredient employed may vary within a relatively wide range. It depends substantially on the nature of the desired effect. The application rates are generally between 1 g (preferably 8 g) and 125 g of active ingredient of the formula (I) per hectare of soil surface, preferably between 2 g and 60 g per ha, more preferably 10 g and 30 g per ha. As an inventive application rate which is a most preferred rate, mention may be made of 10 g to 15 g per ha.

The particularly advantageous effect of the crop-plant tolerance of the active ingredient combinations with added safener that can be employed in the method of the invention is particularly pronounced at certain concentration ratios. Nevertheless it is possible to vary the weight ratios of the compound of the formula (I) to the safener within relatively wide ranges. Preferably there are 1 to 25 parts by weight of the safener and more preferably 3 to 6 parts by weight of safener per part by weight of active ingredient of the formula (I).

The use of the compound of the formula (I) and of its salts is illustrated by the examples below.

### APPLICATION EXAMPLES

A. Postemergence Trials/Field

The compound of the formula (I) was tested under field conditions in Winter wheat in Germany and Poland against the economically significant weed Apera spica-venti. The plot trials were instituted on cultivated land used agriculturally, and the conditions of cultivation and climate can be regarded as being representative over the period under investigation. Areas with a particularly high weed population were selected preferentially.

The active ingredient was applied postemergence (spring) across the area by spraying with a medium droplet size. An appropriate preparation of active ingredient was produced by formulating the active ingredient as a 10 WP (10% w/w water-dispersible powder), mixed with the safener mefenpyr-diethyl as a 15 WG (15% w/w water-dispersible granules) and with alkyl ether sulfates as an additive, and applied with customary amounts of water.

For the assessment of crop tolerance, instances of plant growth inhibition or lightening of the leaf area were rated in % damage in comparison to the development of the untreated control, 1 to 7 weeks after treatment. The herbicidal activity was assessed at a number of times after treatment, based on the development of weeds, as a % reduction in comparison to the untreated control. For these purposes:
0%=no damage to crop or no herbicidal action;
100%=total destruction of the crop or of the weeds, respectively.

The trials carried out show that the compound of the formula (I) is particularly effective in controlling the annual varieties of Apera spica-venti in cereals.

[“% w/w”=percent by weight]

TABLE A
Postemergence trials/field

| | | (I) + mefenpyr- | (I) + mefenpyr- |
|---|---|---|---|
| | | diethyl (7.5 + | diethyl (15 + |
| | Number | 22.5 g a.i./ha) | 45 g a.i./ha) |
| Test plants | of trials | herbicidal action | herbicidal action |
| Apera spica-venti | 5 | 97 | 98 |
| Crop damage (wheat) | 5 | 3 | 4 |

1. The use of the compound 5-methoxy-4-methyl-2-[(4-methoxycarbonyl-2-methylthien-3-yl)sulfonylaminocarbonyl]-2,4-dihydro-3H-1,2,4-triazol-3-one of the formula (I) 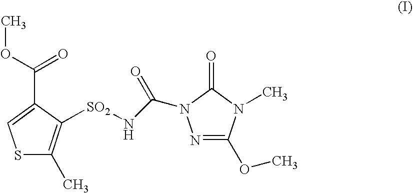
and/or of the salts of the compound of the formula (I) for selectively controlling weeds of the genus Apera in crops of useful plants.

2. A method of selectively controlling weeds of the genus Apera in crops of useful plants, which comprises applying the compound of the formula (I) as claimed in claim 1 and/or salts of the compound of the formula (I) together with surface-active agents and/or customary extenders in crops of useful plants.
